(19) United States
(12) Patent Application Publication
(10) Pub. No.: US 2024/0240340 A1
(43) Pub. Date: Jul. 18, 2024

(54) Separators for Liquid Products in Oxocarbon Electrolyzers

(71) Applicant: Dioxycle, Saint Ouen sur Seine (FR)

(72) Inventors: David Wakerley, Paris (FR); Sarah Lamaison, Paris (FR); Ruperto G. Mariano, South San Francisco, CA (US); Jonathan Maistrello, La Garenne Colombes (FR)

(21) Appl. No.: 18/408,873

(22) Filed: Jan. 10, 2024

Related U.S. Application Data
(63) Continuation-in-part of application No. 18/369,838, filed on Sep. 18, 2023.
(60) Provisional application No. 63/438,519, filed on Jan. 11, 2023.

(51) Int. Cl. C25B 15/08; C25B 3/25; C25B 3/01

(52) U.S. Cl. CPC C25B 15/083; C25B 3/25; C25B 3/01

(57) ABSTRACT

Methods and systems which involve separating liquid products are disclosed herein. A disclosed method includes supplying a volume of oxocarbon carbon to a cathode area of an oxocarbon electrolyzer to be used as a reduction substrate, generating a volume of an organic anion using the reduction substrate, and obtaining a liquid stream from the oxocarbon electrolyzer which includes the volume of the organic anion and a volume of a base. The method also includes generating, using a separation process and from the liquid stream, a first stream and a second separate stream. The separation process separates a volume of cations from the liquid stream. The first stream includes a second volume of the base. The second stream includes a volume of organic acid. The volume of organic acid includes the volume of organic anions. The second volume of the base includes the volume of cations.

### CROSS REFERENCE TO RELATED APPLICATIONS

This application is a continuation-in-part of U.S. patent application Ser. No. 18/369,838, filed on Sep. 18, 2023, which claims the benefit of U.S. Provisional Patent Application No. 63/438,519, filed on Jan. 11, 2023, both of which are incorporated by reference herein in their entireties for all purposes.

### BACKGROUND

There is an urgent need to develop technologies which make the capture or valorization of oxocarbons more economical in highly emitting sectors of the economy. Furthermore, there is an urgent need to reduce emissions related to the production of useful fuels and chemicals in our society and to find alternative ways to produce such fuels sustainably instead of relying on fossil resource extraction and processing for their production. Accordingly, technologies that both generate useful fuels and chemicals, while at the same time using oxocarbon feedstocks that would otherwise have been emitted into the atmosphere, are critically important because they both generate useful chemicals without additional emissions and because the economic value of the useful chemicals can offset the cost of the oxocarbon capture and conversion.

There are at present several economically beneficial methods for the conversion of oxocarbons such as carbon monoxide and carbon dioxide into more valuable species. These include processes such as the hydrogenation of carbon dioxide, solid oxide electrolysis, or low temperature oxocarbon electrolysis. These technologies often produce liquid products, such as organic acids, alcohols, or other hydrocarbons, which have high commercial value once they are purified from the outlet stream.

### SUMMARY

Methods and systems which involve separating liquid products are disclosed herein. The liquid products can be generated during the valorization of oxocarbons. The liquid products can be generated or consumed during the operation of an electrolysis device. The liquid products can be generated or consumed during the operation of an oxocarbon electrolyzer. The liquid products can be generated during the valorization of an oxocarbon in an oxocarbon electrolyzer and separated to produce a concentrated stream of valuable chemicals for commercialization. Alternatively, or in combination, the liquid products can be in a fluid electrolyte of an electrolyzer and can be removed from the electrolyte in order to refresh the electrolyte and the concomitant efficiency of the electrolyzer. The liquid products can include an organic species or an alcohol in a basic fluid. The liquid products can be separated from a base which serves as the electrolyte of the electrolysis device.

As used herein, valorization of oxocarbons refers to the transformation of the carbon and oxygen components of the oxocarbon into useful species of more economically valuable chemicals such as hydrocarbons, organic acids, alcohols, olefins, and N-rich organic compounds. These useful species can be generated in an oxocarbon electrolyzer and separated out using the approaches disclosed herein. Using the approaches disclosed herein, such chemicals can be generated and isolated for use cost-competitively with conventional petrochemical routes and contribute to the development of a carbon circular economy.

One problem with oxocarbon electrolyzers, and some other electrolysis devices, is that they use basic fluid streams in the reactor. For example, the electrolysis of carbon monoxide generally uses basic fluid streams in the reactor to ensure effective conversion. Basic fluid streams are problematic because they can be difficult to separate from ionically charged or miscible species, such as, but not limited to, organic species such as ethanol, acetate, propanol, and propionic acid. This is problematic because such chemicals are some of the valuable chemicals mentioned above that could offset the cost of running the electrolyzer and otherwise capturing and processing the oxocarbons. Separation of such species may require large additional energy requirements to neutralize and/or evaporate them from the output stream of the oxocarbon valorizing technology. These separation requirements add cost to the conversion process and may render the process commercially infeasible from an energetic perspective. For this reason, cost-effective means to separate valuable organic species from an aqueous basic stream will improve the economic viability of environmentally beneficial emission-valorizing systems.

In specific embodiments of the inventions disclosed herein, liquid products are separated in an oxocarbon electrolyzer. The liquid products can be separated from liquid streams or gaseous streams. The liquid products can be referred to as liquid products because they are themselves liquid or because they are solutes in an aqueous solution. The liquid products can be useful species generated during the operation of the oxocarbon electrolyzer. Alternatively, or in combination, the liquid products can be species which degrade the performance of an oxocarbon electrolyzer as they build up in the electrolyte of the oxocarbon electrolyzer. The liquid products can be negatively charged ionic species (i.e., anions) and the liquid products can be separated from a basic stream. The liquid products can be organic anions (e.g., acetate or propionate). The liquid products can include carboxylate or carboxylic acid. Basic streams can be referred to herein as basic streams because they include a base and are meant to be basic in a functioning system. As such, those of ordinary skill will understand that as a byproduct builds up to an unacceptable degree in the basic streams disclosed herein, the stream may be less basic. The liquid products discussed herein can be organic species and the liquid products can be separated from a basic stream. The basic streams disclosed herein could be the electrolyte of an electrolyzer. The liquid products can be organic anions such as carboxylate. The liquid products can be organic anion salts such as carboxylate salts. The liquid products can be acidic, such as carboxylic acid (e.g., acetic acid or propionic acid), and the basic stream can be the electrolyte of an oxocarbon electrolyzer. The liquid products could be in a liquid because they were generated intentionally in a liquid as part of the process of generating a useful species from the oxocarbon, or because they are generated as a byproduct of the process of generating a useful species from the oxocarbon. The liquid products can be taken from an anode area of the electrolyzer, a cathode area of the electrolyzer, or a separating area of the electrolyzer located between the cathode area and anode area if one is present.

In specific embodiments of the inventions disclosed herein, a liquid electrolyte of an oxocarbon electrolyzer is circulated in the oxocarbon electrolyzer for various uses and in various ways. The liquid electrolyte could be circulated from the anode area, from the cathode area, or from a separating area if one is present. In specific embodiments, the liquid electrolyte is circulated by being passed through a separator before being fed back into the electrolyzer. In specific embodiments of the invention, the separator separates out negatively charged ionic species from a liquid stream. In specific embodiments, the separator separates out one or more organic anion species such as carboxylate from a basic liquid stream. In specific embodiments, the separator separates out one or more organic anion salts such as carboxylate salts from a basic liquid stream. In specific embodiments, the separator separates out one or more acidic species, such as a carboxylic acid (e.g., acetic acid or propionic acid) from a basic liquid stream. In specific embodiments, a concentrated stream of base is separated from an acidic species and is used to refresh an electrolyte of the electrolyzer and to maintain a required PH of operation for the electrolyzer above a desired level. In specific embodiments, the liquid electrolyte is circulated from one, two, or three of the aforementioned areas and is circulated by being passed through a common separator, or individual separators for each area, before being fed back to one, two, or three of the aforementioned areas.

In specific embodiments, the liquid electrolyte is circulated from the areas mentioned above and is stored in one or more tanks, or sent to one of multiple separators, prior to being circulated. Storing the electrolyte in the one or more tanks, or sending it to one of multiple separators, allows for liquid products to be separated from the electrolyte using a separating technology that generates purified electrolyte more slowly than the electrolyzer degrades purified electrolyte. In such a system, a chemical generated during the electrolysis can be separated using a separate system operating on one or more of the tanks while another tank of the one or more tanks is used to continue to supply purified electrolyte to the electrolyzer.

In specific embodiments of the inventions disclosed herein, various separating technologies are provided for separating liquid products from a liquid stream. Specific embodiments disclosed herein can separate negatively charged ionic species from a basic stream without acidifying the entire liquid stream, including the base, and thereby operate using lower energy requirements than alternative approaches. The separating technologies include separators that operate using the principle of electrodialysis. The separating technologies include separators operating using the principle of selective binding. The separating technologies include separators using nanofiltration. The separating technologies include separators using Kolbe electrolysis on carboxylate. The separating technologies include separators that pyrolyze carboxylate.

In specific embodiments of the inventions disclosed herein, in which the separating technology is used to separate liquid products for an oxocarbon electrolyzer, and the separating technology includes a separator in the form of an electrodialysis electrolyzer operating using the principle of electrodialysis, dihydrogen generated at the cathode of the electrodialysis electrolyzer can be circulated from the cathode to the anode to reduce the energy requirements of the separator.

### BRIEF DESCRIPTION OF THE DRAWINGS

The accompanying drawings illustrate various embodiments of systems, methods, and other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a flow chart for a set of methods in accordance with specific embodiments of the inventions disclosed herein.

FIG. 2 illustrates a system that can be used to execute specific methods from the set of methods of FIG. 1.

FIG. 3 illustrates a flow chart for a separator process using nanofiltration in accordance with specific embodiments of the inventions disclosed herein.

FIG. 4 illustrates a system that can be used to execute specific methods for separating liquid products using nanofiltration and an acid-base separator in accordance with specific embodiments of the inventions disclosed herein.

FIG. 5 illustrates a system that can be used to execute specific methods for separating liquid products using nanofiltration and an acid-base generator in accordance with specific embodiments of the inventions disclosed herein.

FIG. 6 illustrates an electrodialysis separator using cation exchange membranes in accordance with specific embodiments of the inventions disclosed herein. FIG. 6 also illustrates a flow chart for a set of method steps for the separation process with an electrodialysis separator using cation exchange membranes in accordance with specific embodiments of the inventions disclosed herein.

FIG. 7 illustrates a flow diagram of the operation of an electrodialysis separator using cation exchange membranes integrated with a CO electrolyzer in accordance with specific embodiments of the inventions disclosed herein.

FIG. 8 illustrates an electrodialysis separator using anion exchange membranes in accordance with specific embodiments of the inventions disclosed herein. FIG. 8 also illustrates a flow chart for a set of methods with an electrodialysis separator using anion exchange membranes in accordance with specific embodiments of the inventions disclosed herein.

FIG. 9 illustrates an electrodialysis separator using anion exchange membranes integrated with a CO electrolyzer in accordance with specific embodiments of the inventions disclosed herein. FIG. 9 also illustrates a flow chart for a set of method steps with the electrodialysis separator using anion exchange membranes integrated with a CO electrolyzer in accordance with specific embodiments of the inventions disclosed herein.

FIG. 10 illustrates two bipolar membrane electrodialysis separators using bipolar exchange membranes integrated in accordance with specific embodiments of the inventions disclosed herein. FIG. 10 also illustrates a flow chart for a set of method steps for operating the bipolar membrane electrodialysis separators in accordance with specific embodiments of the inventions disclosed herein.

FIG. 11 illustrates a system that can be used to execute specific methods for separating liquid products using nanofiltration and a bipolar membrane electrodialysis separator in accordance with specific embodiments of the inventions disclosed herein.

FIG. 12 illustrates two multi-cell bipolar membrane electrodialysis separators in accordance with specific embodiments of the inventions disclosed herein.

FIG. 13 illustrates a flow chart for a set of methods using a selective binding separator process in accordance with specific embodiments of the inventions disclosed herein.

FIG. 14 illustrates different phases of operation for an ion-exchange column in a selective binding separator process in accordance with specific embodiments of the inventions disclosed herein.

FIG. 15 illustrates a tubular electrodialysis electrolyzer in accordance with specific embodiments of the inventions disclosed herein.

FIG. 16 illustrates a flow chart for a separator process using Kolbe electrolysis in accordance with specific embodiments of the inventions disclosed herein.

FIG. 17 illustrates a flow chart for a separator process using Kolbe electrolysis to produce ethylene in accordance with specific embodiments of the inventions disclosed herein.

FIG. 18 illustrates a flow chart for a separator process that includes pyrolysis in accordance with specific embodiments of the inventions disclosed herein.

FIG. 19 illustrates a system using multiple tanks to store fluid streams in accordance with specific embodiments of the inventions disclosed herein.

FIG. 20 illustrates a process for obtaining protonating species to be used in a separation process in accordance with specific embodiments of the inventions disclosed herein.

FIG. 21 illustrates a flow chart for a set of method steps for the separation process with an electrodialysis separator using cation exchange membranes in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Methods and systems which involve separating liquid products are disclosed in detail herein. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

In specific embodiments of the inventions disclosed herein, a separator extracts purified streams of liquid products, such as carboxylic acid (e.g., acetic acid and propionic acid), from a basic aqueous stream. The basic aqueous stream may be taken from the output of an oxocarbon electrolyzer. As such, in specific embodiments, the separator may also regenerate a concentrated stream of base that may be added to the anolyte of the oxocarbon electrolyzer in order to maintain one of the required pH and conductivity of operation of the oxocarbon electrolyzer. Those of ordinary skill in the art will recognize that in specific embodiments maintaining the pH of operation contributes to maintaining the conductivity of the electrolyte. Specific embodiments of the invention will be described with reference to oxocarbon electrolyzers, and more specifically with reference to carbon monoxide electrolyzers, as an example of a potential application of the separators disclosed herein. However, those of ordinary skill will recognize that the approaches disclosed herein are more broadly applicable to other oxocarbon electrolyzers, to electrolysis devices generally, and to liquid product separation more broadly.

The basic aqueous stream from which the purified streams of liquid products are extracted could include an anionic species such as carboxylate (e.g., acetate or propionate) which is extracted in the form of carboxylic acid. The basic aqueous stream could include a carboxylate salt such as a metal carboxylate salt (e.g., metal acetate salt). The metal (M) could be various metals such as potassium, sodium, cesium, or lithium. Throughout this disclosure Ac represents acetate, while A represents any anion such as but not limited to Cl⁻, Br⁻, NO³⁻, PO₄³⁻, etc. Throughout this disclosure acetate is used as an example of an organic anion that is mixed with a fluid stream and needs to be separated therefrom. However, those of ordinary skill will recognize that acetate can be replaced with alternative organic anions, such as any carboxylate, in these examples and the principles of the related embodiments will be understood to be sufficiently disclosed. Separating species from the electrolyte of a CO electrolyzer that lowers the pH of the electrolyte and replenishing the hydroxide content of the CO electrolyzer are important goals for improving the performance of a CO electrolyzer. With specific reference to CO electrolysis for the production of useful chemicals, the cathodic electrosynthesis of acetate in alkaline media leads to the stoichiometric consumption of one equivalent of hydroxide electrolyte for every equivalent of carboxylate produced because of charge balance. Additional carboxylate is produced when alcohols such as ethanol and propanol are oxidized to acetate and propionate at the anode, leading to further consumption of hydroxide. Further losses in the hydroxide content of the system anolyte arise from the transport, generation, and/or dialysis of hydroxide to or at the cathode and into the cathode trap, where it is physically segregated from the anolyte. The consumption of hydroxide and/or its inefficient transport to the anode during CO electrolysis leads to a lower electrolyte pH at steady-state relative to initial conditions, which leads to declines in performance because the energy efficiency of earth-abundant anodes for CO electrolysis generally perform best in strongly alkaline media. Lower electrolyte pH also leads to the dissolution of labile species necessary for high performance from the anode (e.g., Ni), possibly followed by their redeposition on the cathode, leading to increase in cell voltage and loss in selectivity for valuable products at the cathode. The consumption of hydroxide also increases cell voltage and energy consumption by lowering solution conductivity, because the specific molar conductivity of carboxylate is lower than that of hydroxide. CO electrolysis systems have only recently reached high productivities such that large amounts of hydroxide are converted during electrolysis, leading to instances where hydroxide consumption becomes a large contributor to decline in performance and loss of electrolyzer lifetime.

Separating amphiphilic species from the electrolyte of an electrolyzer is also an important goal for improving the performance of an electrolyzer. Alkali metal carboxylates and carboxylic acids are amphiphilic substances that also lower the pH of the electrolyte by consuming hydroxide such that there are dual benefits to removing such chemicals from the electrolyte. When the aforementioned chemicals are generated during CO electrolysis and build up in the CO electrolyzer, these substances degrade the hydrophobicity of the cathode and thus impede the efficient transport and conversion of CO. It is thus of interest to actively remove these species from the reaction medium to preserve the rate of CO transport and conversion. Under some conditions, alkali metal carboxylates can also precipitate as solids, leading to impeded gas, ionic, and electronic transport through the electrolyzer and thus reducing overall efficiency.

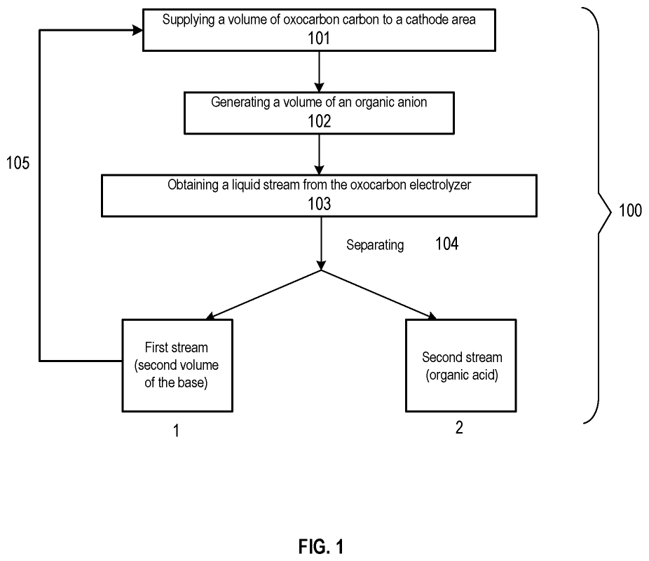

FIG. 1 illustrates a flow chart 100 for a set of methods. The methods include a step 101 of supplying a volume of oxocarbon to a cathode area of an oxocarbon electrolyzer to be used as a reduction substrate. The methods also include a step 102 of generating a volume of an organic anion using the reduction substrate. For example, the organic anion could be carboxylate. The method also includes a step 103 of obtaining a liquid stream from the oxocarbon electrolyzer. The liquid stream could include the volume of the organic anion and a volume of a base. The base could be an alkali metal hydroxide such as potassium hydroxide. The liquid stream could be obtained directly from a chamber of the electrolyzer (i.e., the liquid stream could be a liquid electrolyte of the electrolyzer) or it could be obtained from a gaseous phase area of the electrolyzer using a liquid trap on an output of the gaseous phase area. The method also includes a step 104 of generating, using a separation process and from the liquid stream, a first stream and a second stream. The first stream and the second stream are separate. The separation process separates a volume of a cation from the liquid stream. The cation could be an ionic form of a metal (M) such as potassium, sodium, cesium, or lithium. The first stream includes a second volume of the base. The second stream includes a volume of an organic acid. The organic acid could be carboxylic acid. The volume of the organic acid includes the volume of the organic anion. The second volume of the base can include the volume of the cation.

In specific embodiments, the first stream and the second stream can be formed in different ways depending upon the separator process that is employed. For example, the first stream and the second stream could be generated simultaneously by a separator process that operates on an input stream where the separator includes two outputs such as the electrodialysis reactors described below. As another example, the first stream and the second stream could be generated at different times by a separator process that operates on an input stream where the separator includes a single output that provides the first stream at a first time during one phase of operation of the separator and that provides the second stream at a second time during a different phase of operation of the separator.

In specific embodiments of the invention, the first stream can be recirculated back to the CO electrolyzer 105 such that the pH of the CO electrolyzer can remain sufficiently high. In specific embodiments of the invention, in the alternative or in combination, the second stream can be a stream of byproducts that are removed from the electrolyte of the electrolyzer such that the pH of the CO electrolyzer can remain sufficiently high, or the second stream can be used as a purified source of valuable chemicals that can contribute to the economic operation of the CO electrolyzer. For example, the CO electrolyzer can be designed to produce ethylene, and acetate can be produced as a byproduct that needs to be removed to maintain the pH of the electrolyte. Alternatively, the CO electrolyzer can be designed to produce acetate which is converted to acetic acid to offset the cost of operating the electrolyzer.

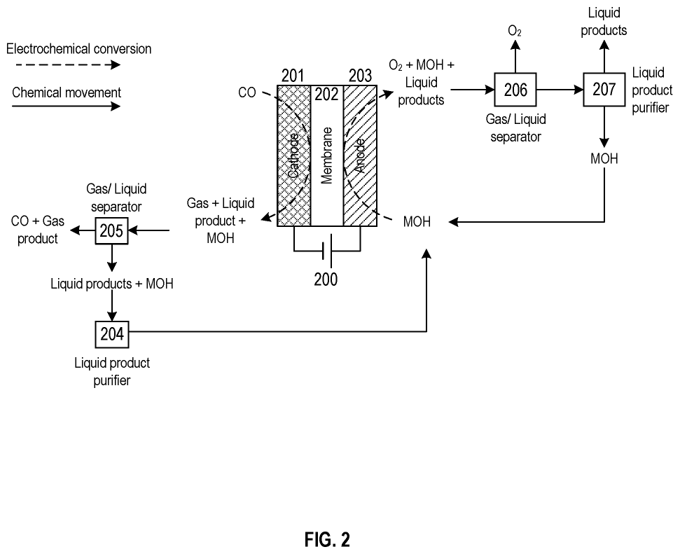

FIG. 2 illustrates a system that can execute methods that are in accordance with some of the methods disclosed with reference to FIG. 1. In FIG. 2, a CO electrolyzer 200 is composed of a cathode area 201 comprising a gas-diffusion layer and a CO-reduction catalyst. The anode catalyst comprises at least one of iridium and ruthenium supported onto a porous titanium-based support of any shape (such as but not limited to a foam, a mesh, a conductive porous transport layer, PTL). The anode catalyst could alternatively comprise at least one of nickel, gold, iron, steel, platinum, cobalt, manganese, titanium, and boron doped diamond. In this case, CO reduction is carried out by the cathode catalyst and the resulting products include one or more of the following: acetate (CH₃COO⁻), ethanol (C₂H₅OH), ethylene (C₂H₄), propionate (C₂H₅COO⁻), and propanol (C₃H₈O), propylene (C₃H₆), produced according to the CO-reduction reactions 1-6:

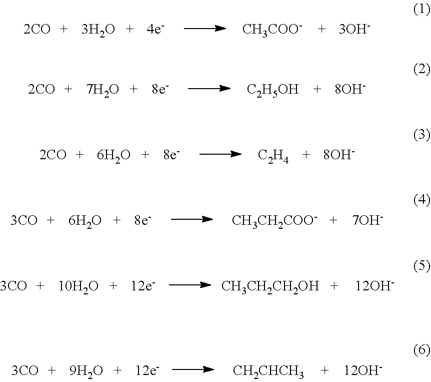

FIG. 2 provides an example of a CO electrolyzer that generates high-added-value products. Coupled liquid product purifiers 204 and 207 are used to separate the high-value liquid products from a basic stream containing MOH. The electrolyzer is installed in a system as depicted in FIG. 2 with MOH as an electrolyte. The aqueous MOH is fed to the anode area 203 which produces O₂ through hydroxide oxidation reaction 7:

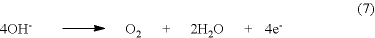

Alternatively, hydrogen oxidation, an organic oxidation, or water oxidation is undertaken as the oxidation reaction.

During operation of the electrolyzer, liquid products may accumulate in the cathode outlet as they are generated by the cathode. Alternatively, the products generated at the cathode may pass across the central membrane or separator 202 of the electrolyzer to the anodic compartment where they accumulate in the anodic electrolyte. To isolate pure streams of the high value liquid product, purifiers or (separators) are used to separate the liquid products from MOH electrolyte (such as but not limited to NaOH, KOH, LiOH, and CsOH). Examples of separators that can be used in these systems are presented below.

In the example of FIG. 2, liquid products are separated from basic fluid streams that are obtained from both the cathode area 201 and the anode area 203, and the purified base is recirculated to the electrolyte on the anode side of the electrolyzer. In alternative approaches, the liquid products can be retrieved from a single area of the electrolyzer (e.g., only the cathode or only the anode). In alternative approaches, the liquid products can be retrieved from a separation area of the electrolyzer between the cathode area 201 and the anode area 203 which is not present in the example of FIG. 2. In the example of FIG. 2, two separate liquid streams are obtained from the electrolyzer and are fed to different separators. However, in alternative approaches, two or more liquid streams obtained from the electrolyzer can be sent to a single separator. In the illustrated case, the cathode area 201 is a gaseous phase area; and the liquid stream is obtained from the anode area using a gas-liquid separator 206. On the cathode side, a gas-liquid product (e.g., a gas product, carboxylate, and alkali metal hydroxide) are passed to a gas-liquid separator 205.

Valuable products such as alcohols and carboxylic acids can be separated from an electrolyte using various approaches as disclosed herein, and a combination of any number of them can be used to attain the purity levels required for a specific application. Such methods include but are not limited to distillation, adsorption, crystallization, solvent extraction, and membrane separation. During distillation, heat is applied to the electrolyte to volatilize alcohols while retaining a larger proportion of water in the condensed phase. The volatilized alcohols can be collected via condensation. During adsorption, the electrolyte is passed through an adsorbent material in a column such as but not limited to activated charcoal, molecular sieves, silica gel, clay, diatomaceous earth, polymer foams, resins, particles, carbon nanotubes, ion exchange resins, cellulose, and others. One component of the electrolyte, such as alcohol, carboxylic acid, or water, selectively adsorbs onto the adsorbent, producing a purified stream at the outlet of the adsorbent column. During crystallization, the electrolyte is concentrated and cooled to a low temperature to selectively precipitate components such as alkali metal carboxylates and alkali metal hydroxides as solids, while retaining alcohols in the liquid phase. Purification is then achieved by removing the solids from the cooled mixture. During membrane separation, the electrolyte is passed through a selective membrane that permits one or more components of the mixture to pass more readily than others. Membrane separation uses an extended surface comprising a polymeric species for the movement/restriction of a particular species in a fluid line. The separator may comprise several layers of the membrane surface to achieve effective separation. On a commercial scale, the membrane can be arranged as a hollow fiber module, a spiral wound module, or some other form. The separation is achieved through a favorable chemical interaction of the membrane with the substance to be removed from the fluid line or through a size of pore tailored for the exclusion of larger molecules within the fluid.

In specific embodiments of the invention, the electrolyte can be acidified before or after distillation to facilitate product separation. For example, an alkaline mixture containing alkali metal carboxylates, alkali metal hydroxide, and alcohols can be subjected to distillation to remove a part of the alcohols, but not alkali metal carboxylates or alkali metal hydroxides present in the mixture. Subsequently, the alcohol-poor alkaline mixture can be acidified to convert the alkali metal carboxylate and alkali metal hydroxide to carboxylic acids, an alkali metal salt and water. This mixture can then be subjected to another distillation process to remove the carboxylic acids from the mixture, yielding separate, high-purity streams of alcohol, carboxylic acids, and water with alkali metal salts. Without acidification, it is difficult to separate metal carboxylate salts from water using distillation because alkali metal carboxylate salts are not volatile. This may impose a larger energy demand because of the requirement to crystallize the alkali metal carboxylate from the processed electrolyte mixture.

In specific embodiments of the invention, a reactive distillation process can also be used to purify the electrolyte stream and reduce total energy demand. As a non-limiting example given by equation 8 below, acid equivalents can be added to the spent electrolyte to acidify the Alkali metal carboxylates, and a catalyst can be used while heating the electrolyte mixture to induce esterification of carboxylic acids with alcohols in the electrolyte (e.g., esterification of acetic acid with ethanol to produce ethyl acetate). As the reaction proceeds, a larger proportion of the carboxylic acid is combined with alcohols to produce a volatile organic ester. By esterifying carboxylic acids with alcohols, reactive distillation provides a route for the carboxylic acid to be effectively separated from the bulk water at a lower temperature than is required to volatilize the carboxylic acid itself, potentially lowering the energy demand of the overall separation process chain.

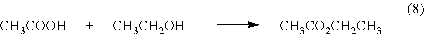

In specific embodiments of the invention, solvent extraction can also be used to separate alcohols and carboxylic acids from electrolyte. During solvent extraction, an organic extracting agent containing one or more solvents such as but not limited to an organic ester, an organic amine-containing molecule, an alcohol, an organic ether, or a hydrocarbon compound is added to the electrolyte mixture containing carboxylic acids and alcohols. During mixture, the carboxylic acids and alcohols dissolve in the organic extraction agent and leave the aqueous electrolyte phase. The carboxylic acids and alcohols are then removed from the organic extraction agent via any number of methods, such as but not limited to distillation, and the organic extraction agent can then be recovered for reuse to extract more product from the aqueous electrolyte stream.

The separation process discussed herein can separate organic ions from the basic liquid streams without using as much energy as alternative approaches. For example, the separation processes can operate to separate organic ions from the basic liquid streams without acidifying the base. These approaches contrast with alternative approaches which require a large amount of energy to generate enough protons to entirely acidify the base in the liquid stream. For example, the processes can instead operate on the principles of electrodialysis in which protons can be recycled between the anode and cathode of the electrolyzer used for the electrodialysis. As another example, the processes can instead operate on the principles of selective binding in which an acid is used to convert the carboxylate salts into carboxylic acid, where the acid can be recovered using low energy electrodialysis. Both examples used in this paragraph include separation processes which include an electrodialysis process. However, additional separation processes disclosed in this specification do not utilize electrodialysis.

### Nanofiltration Separator Processes

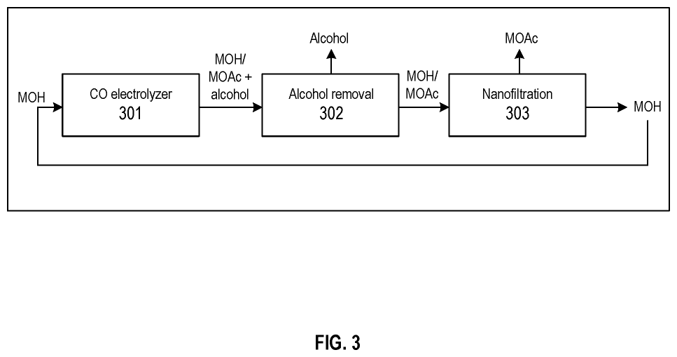

In specific embodiments of the invention, the separating processes disclosed herein can be conducted using the principle of nanofiltration. Nanofiltration can be used to separate MOH/MOAc streams departing an oxocarbon electrolyzer 301. Nanofiltration 303 is a membrane-based technology that separates components in solution using size and Donnan charge exclusion. The separating processes disclosed herein can use a membrane for a nanofiltration process to separate out MOH and MOAc streams. The membrane can be designed to admit MOH while not allowing MOAc to pass through the membrane. An additional mechanism for separation is the dielectric exclusion imposed by differences in hydration energy of specific ions, such that ions with weaker hydration shells can pass through more easily. A simplified diagram of a nanofiltration system for separating a MOH/MOAc solution from the output stream of a CO electrolyzer and an alcohol removal block 302 is shown in FIG. 3. The alcohol removal block is optional. When fed a mixture of MOAc/MOH, a nanofiltration membrane could selectively retain MOAc while allowing MOH to pass through. Upon sufficient separation and concentration, the MOAc can be washed away from the membrane with water or simply diverted for downstream processing for valorization. One side of the membrane could be monitored for carboxylate concentration (or for the concentration of any organic anion) or MOH concentration, and the washing away could be conducted when the concentration passes a threshold by going above or below a target concentration. The nanofiltration membrane could be replaced with a reverse osmosis membrane to achieve the same effect.

Increased rates of nanofiltration can be driven by a pressure of 10-30 bar to force permeation. Retention efficiency of a solute on one side of the membrane decreases with concentration. This is advantageous if a single-pass anolyte feed is used and/or the crystallization yield is not worth the energy input of water removal. The energy input largely arises from the pressurization requirement of the headspace above the liquid being purified.

The materials used for nanofiltration are characterized by nanometric pores below 10 nm and can be made of polymeric materials such as PVDF, PET or polycarbonate, bio-derived materials such as cellulose, and nano porous metal arrays made of alumina. The membranes can also be composed of a combination of an active material such as polyamide or polyvinyl alcohol or sulfonated polyethersulfone and a support material such as polyester, polysulfone, or melamine polyamine.

### Concentrator Processes

In specific embodiments, the separation process can include a concentration process followed by a second process that operates more effectively with higher concentration inputs. For example, the separation process can include a nanofiltration process to increase the concentration of a liquid stream and an acid-base separation process to produce acid and base streams from that concentrated liquid stream. Given that any organic salt, such as acetate, must be acidified before purification, and that acidification will require both residual alkali metal hydroxide and organic salt be protonated indiscriminately, the act of first concentrating liquid products can lower the amount of acid that must be used during purification. In specific embodiments of the invention, the second process can be any acid-base separation process. For example, the process could utilize the electrodialysis processes disclosed below, a selective binding process as described below, or an acid-base generator as disclosed below.

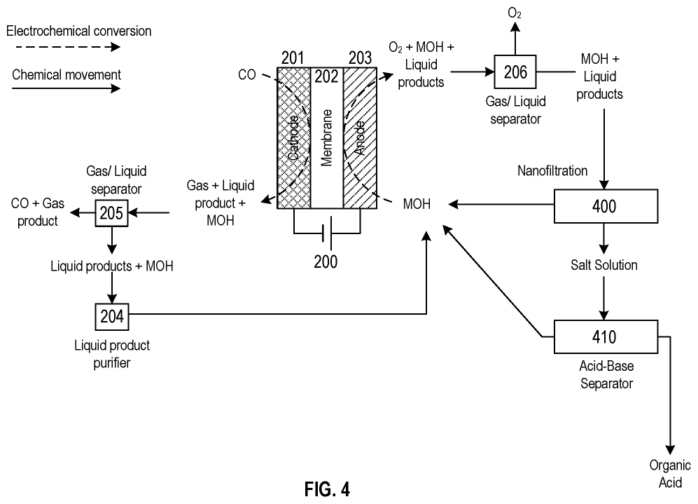

FIG. 4 provides an illustration of a block diagram for a separation process. The separation process in FIG. 4 includes a concentration process that is conducted by nanofiltration block 400 and a second process conducted by acid-base separator 410. In the illustrated embodiment, the nanofiltration block 400 accepts a fluid stream having alkali metal hydroxide and additional liquid products including carboxylate salts. The nanofiltration block 400 separates out alkali metal hydroxide from the carboxylate salts to generate a salt solution. The salt solution will include the carboxylate salts and left over alkali metal hydroxide. As shown, the salt solution is provided to acid-base separator 410. The acid-base separator 410 takes in the salt solution and outputs organic acid on a separate stream from base in the form of alkali metal hydroxide. The alkali metal hydroxide from the nanofiltration block 400 and from the acid-base separator 410 can be the first stream produced by the overall separation process disclosed herein and can be recirculated to maintain the pH of the electrolyte in the CO electrolyzer 200. The organic acid from the acid-base separator 410 can be provided in an output stream that is the second stream provided by the overall separation processes disclosed herein.

### Acid-Base Generator Processes

In specific embodiments of the invention disclosed herein, the separating process can include an acid-base generator process. The acid-base generator could generate acid which is used to acidify an organic salt into an organic acid and thereby make it easier to separate organic acid from a liquid solution containing other salts. The acid generated could be used to convert organic salts, such as acetate or propionate salts, into organic acids. In specific embodiments, the generated base could be recirculated to the electrolyte of the oxocarbon electrolyzer to maintain the pH of the electrolyte. In specific embodiments, the acid-base generator is used in a separating process that is down stream of a concentrating process such that the amount of acid that must be generated can be minimized. In specific embodiments, the concentrating process can be a nanofiltration process. In specific embodiments, the acid-base generator can include a chlor-alkali electrolyzer, that produced hydrogen and chlorine gas, and a reactor that converts the hydrogen and chlorine gas into hydrochloric acid. The reaction of the generated acid with the organic salt can create a salt based on the alkali metal present in the system, for example potassium chloride (KCl), that may be fed back into the acid-base generating block.

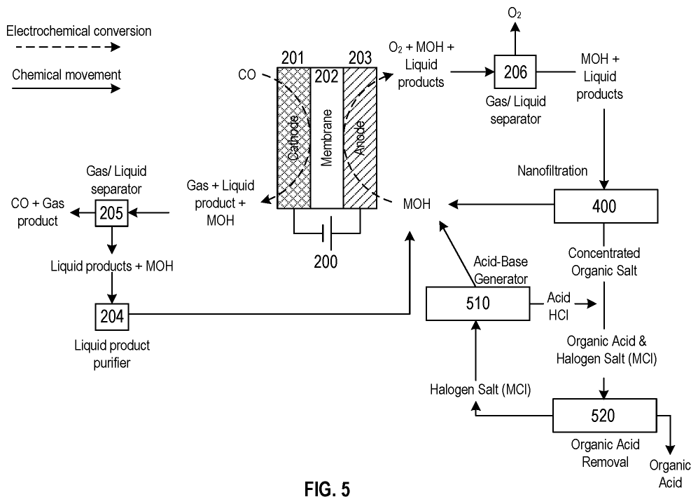

FIG. 5 illustrates a system with similar blocks to those of FIGS. 2 and 4 with similar blocks identified using the same reference numbers. FIG. 5 differs in that the illustrated separating process uses an acid-base generator 510 and an organic acid removal system 520. In the illustrated case, a stream containing an organic salt (e.g., potassium acetate, potassium propionate and potassium hydroxide) is released from the anodic stream of the oxocarbon electrolyzer. In the illustrated case, potassium is represented by the generic alkali metal M. In a first step of the organic acid purification, the liquid is compressed and is fed to a nanofiltration membrane such as a membrane in nanofiltration block 400. The membrane preferentially allows alkali metal hydroxide to pass, leading to the concentration of an organic salt (e.g., potassium propionate and potassium acetate) in the stream before the membrane. The filtered alkali metal hydroxide salt (e.g., potassium hydroxide) can be recirculated to the oxocarbon electrolyzer to replenish the electrolyte. The concentrated organic salt solution can then be fed out of the main electrolyte loop using any of the processes described above with respect to the nanofiltration process.

The concentrated organic salt solution can be subjected to acidification from acid produced by acid-base generator 510. In the illustrated case, the acid is illustrated as hydrochloric acid. However, any acid with pKa below that of the organic salt, such as certain halogen acids (e.g., HBr, HI), can be used in place of hydrogen chloride. In the illustrated case, the acidified concentrated organic salt solution will comprise organic acid and aqueous alkali metal chloride salts (MCl). However, in alternative embodiments, the solution will comprise halogen salts or other salts based on the acid generated by acid-base generator 510. The organic acids can be removed from the solution using an organic acid removal system 520. The remaining salt solution of halogen salts, or other salts based on the acid generated by acid-base generator 510, can then be recirculated to the acid-base generator 510. The organic acid removal system 520 can utilize techniques for separating neutral organic species from aqueous solution such as distillation or organic extraction processes.

The acid-base generator 510 can be any block that produces acid and base from a salt solution. For example, the block can be one of the electrodialysis separators disclosed below. Alternatively, the block can be a chlor-alkali reactor that produces hydrogen and chlorine gas coupled with a reactor that produces hydrochloric acid from hydrogen and chlorine gas. In specific embodiments, the chlor-alkali reactor can utilize oxygen produced as a byproduct by the CO electrolyzer. The output of the chlor-alkali reactor can also have a chloride removal block to purify the alkali metal hydroxide before it is recirculated to the CO electrolyzer.

In one example, a stream containing potassium acetate, potassium propionate and potassium hydroxide can be released from the anodic stream of an oxocarbon electrolyzer as the ‘MOH+liquid products’. In the first step of the organic acid purification, the liquid can be compressed and fed to a nanofiltration membrane. The membrane preferentially allows potassium hydroxide to pass, leading to the concentration of potassium propionate and potassium acetate in the stream before the membrane. This concentrated organic salt solution can then be fed out of the major electrolyte loop. In a second step, a chloralkali electrolyzer is implemented, which takes streams of alkali metal chlorides, such as KCl, in order to form dihydrogen and potassium hydroxide at the cathode, and Cl₂ at the anode. The basic stream can be recirculated to the oxocarbon electrolyzer as the electrolyte, which replaces base that may have been consumed in the production of the acetate or propionate. The generated dihydrogen and Cl₂ can then be fed to a separate reactor where at elevated temperatures they react to produce HCl. The chloralkali reactor and that separator reactor can take the place of acid-base generator 510 in FIG. 5. This HCl may be then fed to the concentrated organic solid stream where it generates acetic acid, propionic acid and aqueous potassium chloride. The neutralized organic acids may then be removed through known techniques that separate neutral organic species from aqueous solution, such as distillation or organic extraction. The KCl stream may then be fed back into the chloroalkali reactor to repeat the process. The KCl stream can take the place of the halogen salt in FIG. 5.

### Electrodialysis Separator Processes

In specific embodiments, the separation process is an electrodialysis process. The process can utilize an electrolyzer where the liquid stream is applied to the anode area or the cathode area of the electrolyzer. For the avoidance of doubt, the electrolyzer in the electrodialysis separator is different than the electrolyzers mentioned in the previous section (i.e., the electrolyzer from which the liquid stream is originally obtained). First and second streams can be obtained from the electrodialysis electrolyzer where the first stream and the second stream are separate. The separation process separates a volume of a cation from the liquid stream. The cation could be an ionic form of an alkali metal (M) such as potassium, sodium, cesium, or lithium. The first stream includes a second volume of the base. The second stream includes a volume of an organic acid. The organic acid could be carboxylic acid. The volume of the organic acid includes the volume of the organic anion. The second volume of the base can include the volume of the cation. In specific embodiments of the invention, the electrodialysis separator uses water as a feedstock and produces dihydrogen and dioxygen. The dihydrogen or dioxygen can be valorized in a separate process or via recirculation into the same or a separate separator. For example, the dihydrogen can be used to generate a protonating species to be used by the electrodialysis separator or can be used as an energy source for the electrolyzer from which the liquid stream is being harvested.

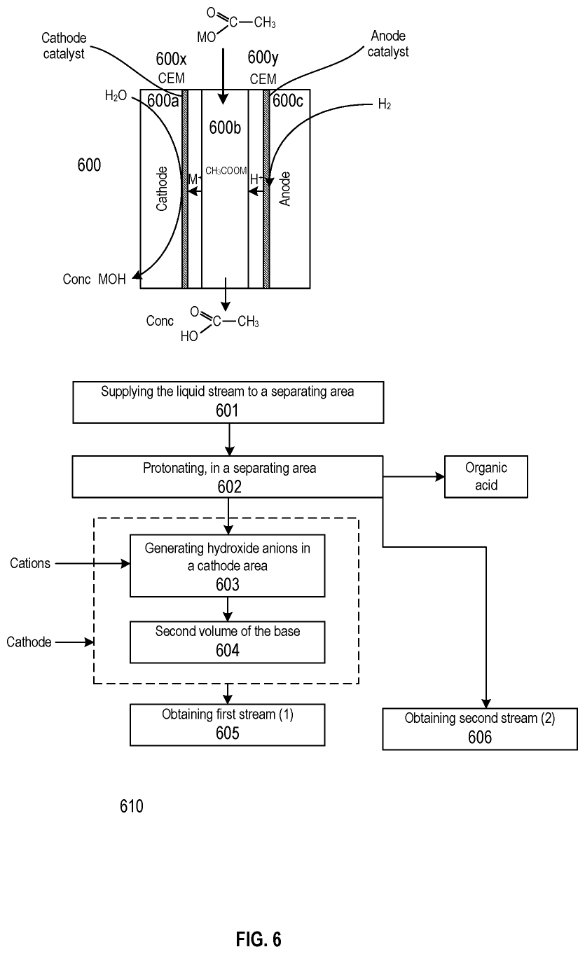

FIG. 6 illustrates an electrodialysis electrolyzer 600 that can be used to separate useful products from a liquid stream, and/or to refresh an electrolyte by removing byproducts, in accordance with embodiments disclosed herein. As illustrated, an anode area 600c of the electrodialysis electrolyzer is isolated from the separating area 600b of the electrodialysis electrolyzer by a cation exchange membrane 600y, the separating area 600b of the electrodialysis electrolyzer is located between the anode area 600c of the electrodialysis electrolyzer and the cathode area 600a of the electrodialysis electrolyzer 600, and the cathode area 600a of the electrodialysis electrolyzer 600 is isolated from the separating area 600b of the electrodialysis electrolyzer 600 by a second cation exchange membrane 600x. The electrodialysis electrolyzer 600, and any of the electrodialysis techniques discussed herein, can be used as the liquid products purifier 207 in FIG. 2 or the acid-base separator 410 in FIG. 4.

FIG. 6 also includes a flow chart 610 for a set of separation processes including the steps of supplying the liquid stream to a separating area of an electrodialysis electrolyzer 601, protonating 602, in the separating area and using a volume of a protonating species, the volume of the organic anion to generate the volume of the organic acid, and generating a volume of hydroxide anions in a cathode area of the electrodialysis electrolyzer 603. In accordance with these steps, the volume of hydroxide anions and the volume of cations combine in the cathode area of the electrodialysis electrolyzer to generate the second volume of a base in the cathode area of the electrodialysis electrolyzer 604. The flow chart continues with a step of obtaining a first stream (1) from the cathode area of the electrodialysis electrolyzer 605 and obtaining a second stream (2) from the separating area of the electrodialysis electrolyzer 606. The first stream can be a concentrated stream of base that can be used as the electrolyte for an electrolyzer that generated the liquid stream which was applied to the separating area. The second stream can be a concentrated stream with an organic anion in the form of an organic acid. In the example of FIG. 6, the first stream is the output of the cathode area and is concentrated alkali metal hydroxide, and the second stream is the output of the separating area and is concentrated carboxylic acid.

The separator processes described with reference to FIG. 6 can be used to separate any combination of an organic anion and base. The separator can also be integrated with an oxocarbon electrolyzer.

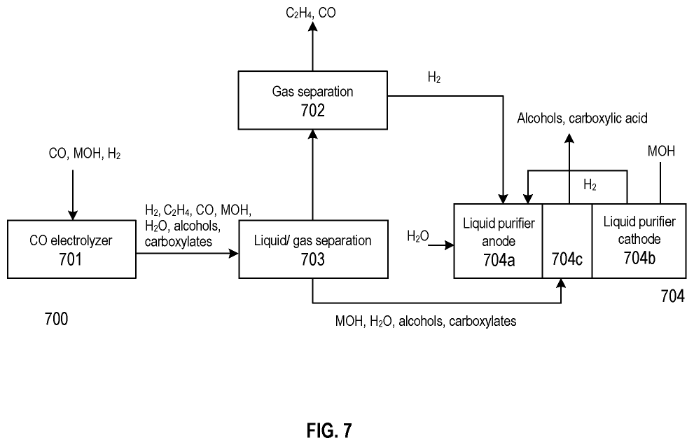

FIG. 7 illustrates a system 700 in which an electrodialysis electrolyzer 704 such as that illustrated in FIG. 6 has been integrated with a CO electrolyzer 701. The liquid products of a CO electrolyzer 701 can be separated from either the cathode output, anode output or both using a separator 704c such as the one presented in FIG. 6. A stream of MOH, water, alcohol, and carboxylate is passed from a liquid/gas separation block 703 to a separator 704c. In FIG. 6, the separating area 600b conducts the separation/purification of acetic acid from an acetate/MOH stream, however this device could be used on any combination of organic anion and base. The separating area 600b uses cation exchange membrane 600x, cation exchange membrane 600y, and electrodialysis to concentrate a stream of acetic acid. Also, while not illustrated, dihydrogen is generated along with MOH at the cathode 704b. This example device uses cation exchange membrane 600x and cation exchange membrane 600y to facilitate the purification. The organic anion is protonated to form a neutral species from the transfer of a proton across a cation exchange membrane 600y next to the anode. The protons come from the anodic oxidation reactions. Selective movement of cation to the cathode (in this case M) through a cation exchange membrane 600x situated next to the cathode ultimately results in the isolation of carboxylic acid in the separating area. The hydroxide anion generated by the cathode then forms a concentrated stream of base, which then may be injected back into the electrolyte of the electrolyzer from the output of the cathode area.

In specific embodiments of the invention, the energy demands of the separating area 600b can be reduced by provisioning a substrate that is more reducible than water or protons, such as but not limited to one or more of dioxygen, nitrate, chlorine, bromine, metal ions, metal oxides, and/or metal complexes. The more reducible substrate can be advantageously derived from an abundant upstream source, such as waste streams and/or the output of an electrolyzer. For example, dioxygen can be provided to the separator from an upstream CO electrolyzer, valorizing the dioxygen produced by the CO electrolyzer and lowering the energy demand of the separator. In the case of provisioning dioxygen to the separator's cathode, the standard cell potential of the separator is made more exergonic by −118.7 KJ/mol CH₃COO⁻ (1.23 V) because the standard reduction potential of O₂ is 1.23 V more positive than that of H₂O.

In specific embodiments of the invention, excess hydrogen gas sourced from another process (such as polymerization, electrolysis, hydrocarbon reforming) is used to reduce the energy demand of the purification system. If the electrolyzer generates hydrogen at the cathode 704b as a by-product, this hydrogen gas may be injected into the purifier to be oxidized as shown in FIG. 6 (the dihydrogen delivered to the anode) and FIG. 7 (the dihydrogen from the gas separation 702 block to the anode of the electrodialysis electrolyzer). Dihydrogen generated at the cathode 704b of the separator/purifier may also be recycled to the anode 704a to lower the energy consumption of the device. It has not been obvious to integrate parasitic dihydrogen into an electrodialysis process because it is typically uneconomical to do so. In specific embodiments of the invention, the electrodialysis system represents a method to extract value from dihydrogen that cannot otherwise be valorized. For instance, valorizing dihydrogen into commercial grade may require other downstream capital equipment and process steps, such as compression and transportation, that may be prohibitive to implement for the operator of a carbon monoxide electrolysis plant. Thus, the energy losses associated with generating parasitic dihydrogen during CO electrolysis can be partially recovered using the electrodialysis unit while simultaneously reducing the exogenous dihydrogen and power demand of the electrodialysis process, translating to process synergy.

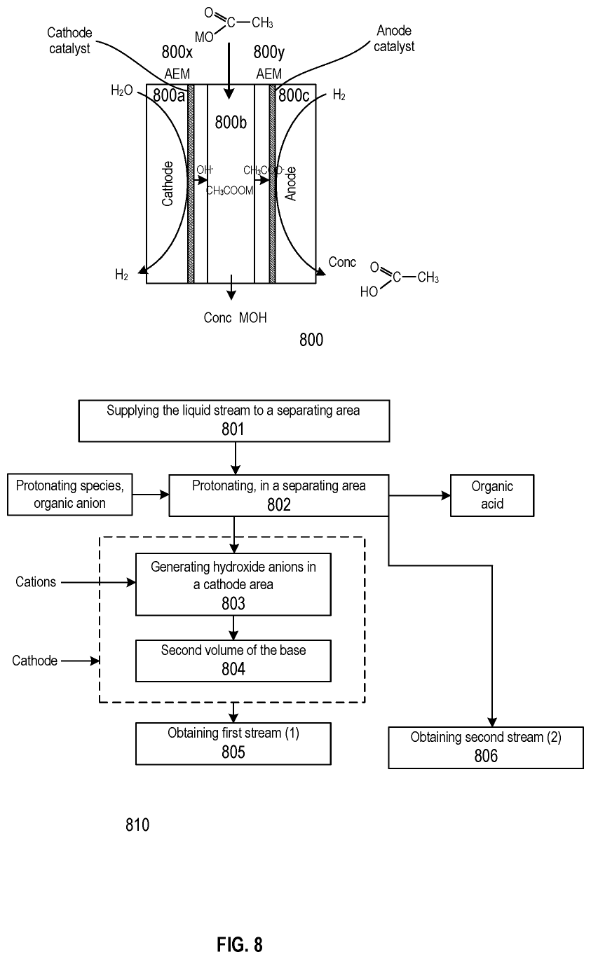

FIG. 8 illustrates an electrodialysis electrolyzer 800 that can be used to separate useful products from a liquid stream, and/or to refresh an electrolyte by removing byproducts, in accordance with embodiments disclosed herein. As illustrated, the anode area 800c of the electrodialysis electrolyzer is isolated from the separating area 800b of the electrodialysis electrolyzer by an anion exchange membrane 800y, the separating area 800b of the electrodialysis electrolyzer 800 is located between the anode area 800c of the electrodialysis electrolyzer 800 and the cathode area 800a of the electrodialysis electrolyzer 800, and the cathode area 800a of the electrodialysis electrolyzer 800 is isolated from the separating area 800b of the electrodialysis electrolyzer 800 by a second anion exchange membrane 800x. The electrodialysis electrolyzer 800 can be used as the liquid products purifier 207 in FIG. 2 or the acid-base separator 410 in FIG. 4

FIG. 8 also includes a flow chart 810 for a set of separation processes including the steps of supplying the liquid stream to a separating area of an electrodialysis electrolyzer 801, protonating, in an anode area of the electrodialysis electrolyzer and using a volume of a protonating species, the volume of the organic anion to generate the volume of the organic acid 802, and generating a volume of hydroxide anions in a cathode area of the electrodialysis electrolyzer 803. The volume of hydroxide anions and the volume of cations combine to generate the second volume of the base in the cathode area of the electrodialysis electrolyzer 804. The flow chart also includes the steps of obtaining a first stream from the separating area of the electrodialysis electrolyzer 805 and obtaining a second stream from the anode area of the electrodialysis electrolyzer 806. The first stream can be a concentrated stream of base that can be used as the electrolyte for an electrolyzer that generated the liquid stream which was applied to the separating area. The second stream can be a concentrated stream with an organic anion in the form of an organic acid. In the example of FIG. 8, the first stream is the output of the separating area and is concentrated alkali metal hydroxide, and the second stream is the output of the anode area and is concentrated carboxylic acid.

In this example, the liquid products are separated from either the cathode output, anode output or both through the separator presented in FIG. 8 for the separation/purification of acetic acid from an acetate/MOH stream. However, this device could be used on any combination of organic anion and base. FIG. 8 provides an example of a separator that can be used downstream of a CO electrolyzer that uses anion exchange membranes (AEMs), such as anion exchange membrane 800x and anion exchange membrane 800y, and electrodialysis to concentrate a stream of acetic acid. The device uses anion exchange membrane 800x and anion exchange membrane 800y to facilitate the purification. The organic anion is protonated to form a neutral species as it transfers from the central stream through the anion exchange membrane to the anode. The protons come from anodic oxidation reactions. Selective movement of hydroxide generated at the cathode through the other anion exchange membrane 800x situated next to the cathode then generates a central channel containing concentrated base, which then may be injected into the electrolyte of the electrolyzer. If the electrolyzer generates hydrogen at the cathode as a by-product, this gas may be injected into the separator to be oxidized at the anode. Dihydrogen generated at the cathode of the separator may also be recycled to the anode to lower the energy consumption of the device. This separator can be used in a similar configuration to FIG. 7, but with different outputs from the electrolyzer compartments (e.g., the base will be recovered from the separator area).

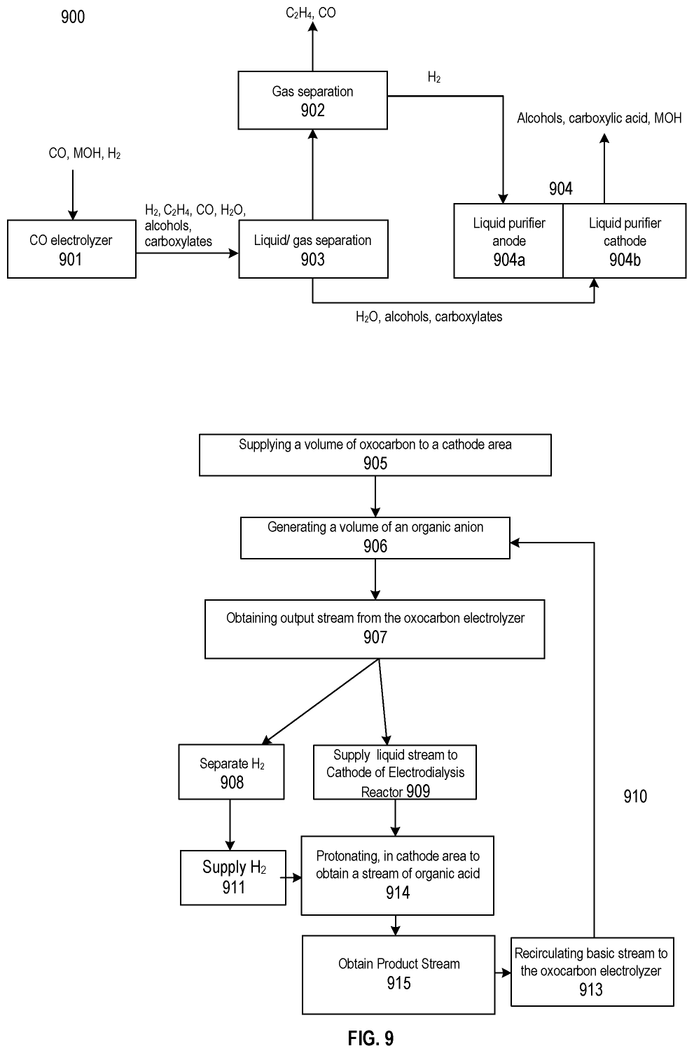

FIG. 9 provides an example of a system 900 with a separator for an oxocarbon electrolyzer 901 electrolyte using electrodialysis where the electrodialysis electrolyzer does not include a central separator area. FIG. 9 also includes a flow chart 910 for a set of methods that can be practiced by system 900. The flow chart includes a step of supplying a volume of oxocarbon carbon to a cathode area of an oxocarbon electrolyzer to be used as a reduction substrate 905, a step of generating a volume of an organic anion using the reduction substrate 906, and a step of obtaining an output stream with a volume of dihydrogen from the oxocarbon electrolyzer 907. The output stream includes the volume of the organic anion. In the illustrated case, the organic anion is a carboxylate. The flow chart also includes a step of separating a volume of dihydrogen from the output stream 908 and supplying the volume of dihydrogen to an anode area of the electrodialysis electrolyzer 911. The flow chart also includes a step of supplying the second liquid stream to a cathode area of an electrodialysis electrolyzer 909. The flow chart also includes a step of protonating, in the cathode area and using a volume of protons from the volume of dihydrogen, a volume of the organic anion to generate a volume of an organic acid 914 and obtaining a product stream from the cathode area of the electrodialysis electrolyzer 915. The product stream includes the volume of the organic acid which has been converted from carboxylates by the electrodialysis electrolyzer 904. Further, while not shown, a basic stream can be recovered from the product stream using the approaches disclosed herein and recirculated to the oxocarbon electrolyzer in a step 913. The basic stream can be an electrolyte of the electrolyzer with a pH that has been lowered owing to the removal of byproducts from the electrolyte, or it can be a basic fluid that can be used to refresh the electrolyte.

In specific embodiments of the invention, the separation processes include providing dihydrogen into the anode area 904a of a separator 904 such as the separator in FIG. 9. Such approaches can obviate the use of a central compartment to cause the separation and thus lower the energy requirement of the separation. Operating without a central compartment can reduce the ohmic loss of the separator thereby resulting in lower energy consumption. In these embodiments, the liquid stream with the organic anion can instead be fed into the cathode area 904b of the electrodialysis electrolyzer from liquid/gas separator 903 while dihydrogen can be provisioned into the anode area 904a of the separator 904 from the gas separation unit 902. During operation, protons produced by the anodic oxidation of water or dihydrogen from the anode compartment can migrate across the membranes and into the cathode area 904b, where the protons can recombine with the carboxylate. Embodiments without a central separator compartment would be well suited to a system that uses a carboxylate-rich and alkali metal hydroxide-poor solution as its feedstock to produce a concentrated stream of carboxylic acid at the separator outlet.

As shown in FIG. 9, the gas separation unit 902 can provide hydrogen that is obtained from the CO electrolyzer. Accordingly, the flow chart also includes steps of generating a volume of output gas using the reduction substrate, separating the liquid stream from the volume of output gas using a liquid-gas separator, and separating the volume of dihydrogen from the volume of output gas. This is the volume of dihydrogen that can be supplied to the anode of the electrodialysis electrolyzer 911 as in the illustrated example. The approach provides the same benefits as mentioned above with respect to FIG. 7.

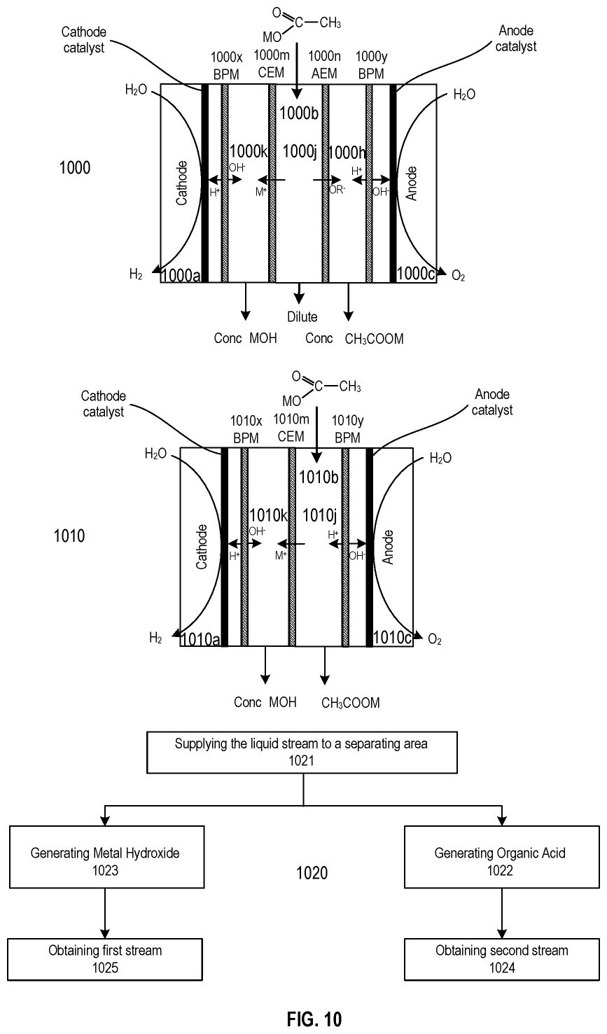

FIG. 10 illustrates an electrodialysis electrolyzer 1000 that can be used to separate useful products from a liquid stream, and/or to refresh an electrolyte by removing byproducts, in accordance with embodiments disclosed herein. Electrodialysis electrolyzer 1000 is a bipolar membrane electrodialysis electrolyzer. As illustrated, the anode area 1000c of the electrodialysis electrolyzer is isolated from the separating area 1000b of the electrodialysis electrolyzer by a bipolar exchange membrane 1000y. The separating area 1000b of the electrodialysis electrolyzer 1000 is located between the anode area 1000c of the electrodialysis electrolyzer 1000 and the cathode area 1000a of the electrodialysis electrolyzer 1000, and the cathode area 1000a of the electrodialysis electrolyzer 1000 is isolated from the separating area 1000b of the electrodialysis electrolyzer 1000 by a second bipolar exchange membrane 1000x. The separating area 1000b includes three separate chambers which are isolated from each other by a cation exchange membrane 1000m and an anion exchange membrane 1000n. The separate chambers can be referred to as a separating chamber 1000j, a base chamber 1000k, and an acid chamber 1000h.

FIG. 10 also illustrates an electrodialysis electrolyzer 1010 that can be used to separate useful products from a liquid stream, and/or to refresh an electrolyte by removing byproducts, in accordance with embodiments disclosed herein. In the case of electrodialysis electrolyzer 1010, the, system uses a single cation exchange membrane 1010m between a first bipolar membrane 1010y and a second bipolar membrane 1010x. Electrodialysis electrolyzer 1010 is a bipolar membrane electrodialysis electrolyzer. As illustrated, the anode area 1010c of the electrodialysis electrolyzer is isolated from the separating area 1010b of the electrodialysis electrolyzer by a bipolar exchange membrane 1010y. The separating area 1010b of the electrodialysis electrolyzer 1000 is located between the anode area 1010c of the electrodialysis electrolyzer 1010 and the cathode area 1010a of the electrodialysis electrolyzer 1010, and the cathode area 1010a of the electrodialysis electrolyzer 1010 is isolated from the separating area 1010b of the electrodialysis electrolyzer 1010 by a second bipolar exchange membrane 1010x. The separating area 1010b includes two separate chambers which are isolated from each other by a cation exchange membrane 1010m. The separate chambers can be referred to as a separating chamber 1010j and a base chamber 1010k.

FIG. 10 also includes a flow chart 1020 for a set of separation processes including the steps of supplying a liquid stream to a separating area of an electrodialysis electrolyzer 1021. This step can involve supplying a solution with an organic salt to separating chamber 1000j or separating chamber 1010j. The organic salt solution can be provided directly from an oxocarbon electrolyzer where the organic salt (e.g., alkali metal acetate salt) is being produced intentionally or as a byproduct in the electrolyte of the oxocarbon electrolyzer. The solution can be provided after being processed with a nanofiltration membrane to increase the concentration of the organic salt. The bipolar electrodialysis electrolyzes can be used as an acid-base generator such as acid-base generator 510 in the process diagrams presented above or as an acid-base separator such as acid-base separator 410 in the process diagrams presented above.

In the example of electrodialysis electrolyzer 1000, the process can continue with migrating the organic anion, that is present in the organic salt, across the anion exchange membrane and protonating, in the acid chamber of the electrodialysis electrolyzer and using a volume of a protonating species, the volume of the organic anion to generate the volume of the organic acid 1022. The volume of the protonating species can be generated at the anode such as through the oxidation of hydrogen or water.

In the example of electrodialysis electrolyzer 1010, the process can continue with protonating, in the separating chamber of the electrodialysis electrolyzer and using a volume of a protonating species, the volume of the organic anion to generate the volume of organic acid 1022. The volume of the protonating species can be generated at the anode such as through the oxidation of hydrogen or water and can be provided across a bipolar exchange membrane such as bipolar exchange membrane 1010y.

The process can also include migrating the alkali metal cation from the organic salt across the cation exchange membrane and combining it with hydroxide in the base chamber to generate a volume of a base 1023. The base is in the form of alkali metal hydroxide. The volume of hydroxide anions can be generated in a cathode area of the electrodialysis electrolyzer. The volume of hydroxide anions and the volume of cations combine to generate a volume of the base in the base chamber of the electrodialysis electrolyzer.

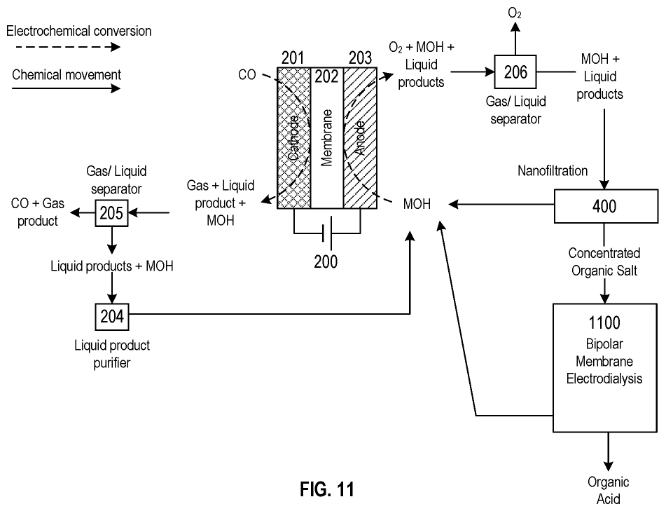

The flow chart also includes the steps of obtaining a first stream from the base chamber of the electrodialysis electrolyzer 1025 and obtaining a second stream from the electrodialysis electrolyzer 1024. In the example of electrodialysis electrolyzer 1000 this step involves obtaining the acid from the acid chamber 1000h. In the example of electrodialysis electrolyzer 1010 this step involves obtaining the acid from the separating chamber 1010j. The first stream can be a concentrated stream of base that can be used as the electrolyte for an electrolyzer that generated the liquid stream which was applied to the separating area. The second stream can be a concentrated stream with an organic anion in the form of an organic acid. In the example of FIG. 11, the first stream is the output of the base chamber and is concentrated alkali metal hydroxide which is cycled back to the oxocarbon electrolyzer such as CO electrolyzer 200, and the second stream is the output of the acid area and is concentrated carboxylic acid.

These separators take advantage of ion exchange membranes and electromigration to selectively produce streams of concentrated acid and base. Upon application of potential, the ions in the organic salt solution are separated based on their charges with cations attracted to the cathode and anions attracted to the anode. At the same time, the potential invokes water dissociation in the bipolar membrane, which generates an equivalent of base (OH) and an equivalent of acid (H⁺) during electrodialysis. Following this, OH joins with the alkali metal cation from the organic salt input and H⁺ joins with the organic anion. This produces a stream of concentrated MOH and a stream of concentrated organic acid (e.g., acetic acid and propionic acid). The neutralized organic acids may then be removed through known techniques that separate neutral organic species from aqueous solution, such as distillation or organic extraction.

FIG. 11 illustrates an example of a bipolar electrodialysis electrolyzer 1100 being used as an acid-base separator at in FIG. 4. As illustrated, nanofiltration is followed by the use of a bipolar membrane electrodialysis electrolyzer 1100. In this case, a stream containing metal carboxylate salt and alkali metal hydroxide are released from the anodic stream of the oxocarbon electrolyzer. In the first step of the organic acid purification, the liquid is compressed and fed to a nanofiltration membrane. The membrane preferentially allows alkali metal hydroxide to pass, leading to the concentration of metal carboxylate salts in the stream before the membrane. This organic salt solution is then fed out of the major electrolyte loop. In a second step, this concentrated organic salt is fed to a bipolar membrane electrodialysis electrolyzer 1100. As was described with reference to FIG. 10 this produces a stream of alkali metal hydroxide that can be recirculated to the oxocarbon electrolyzer to maintain a pH of the electrolyte and a stream of organic acid.

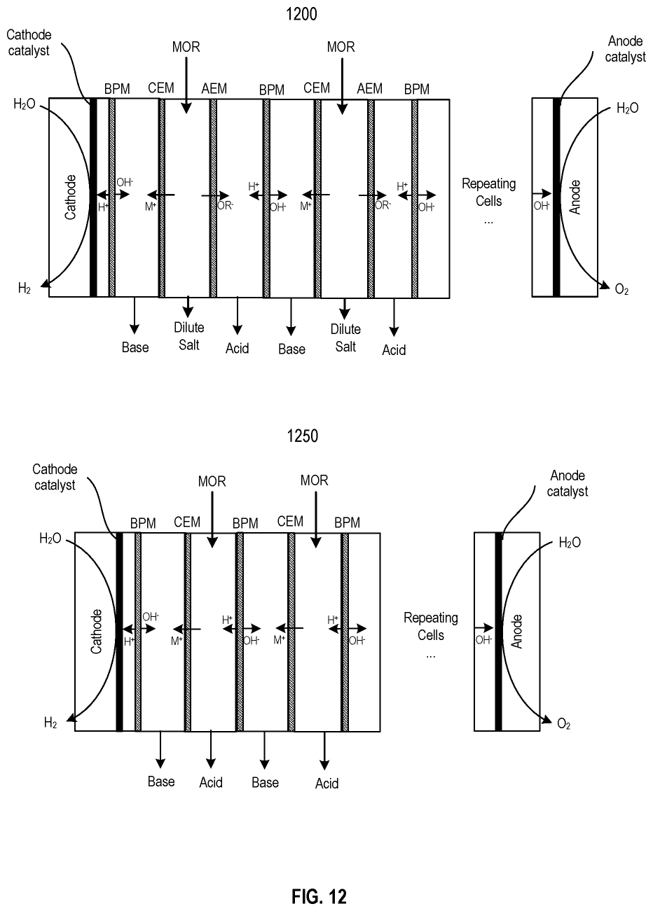

One advantage of the bipolar membrane electrodialysis electrolyzer technology is its amenability to larger scales, as a series of membranes can be stacked in series to achieve higher separation capacity, as shown in FIG. 12. This illustration shows how the number of cells in a bipolar membrane electrodialysis electrolyzer may be repeated to increase the separation capacity of the cell. Each cell can take in the same amount of organic salt solution (MOR) and produce an equivalent amount of base and organic acid as the system shown in FIG. 10. In particular, electrodialysis electrolyzer 1200 is an example that uses a series of membranes that are arranged according to the electrodialysis electrolyzer 1000 from FIG. 10, and electrodialysis electrolyzer 1210 is an example that uses a series of membranes that are arranged according to the principle of electrodialysis electrolyzer 1200 from FIG. 12.

### Selective Binding Separator Processes

In specific embodiments of the invention, the separating processes disclosed herein can be conducted using the principle of selective binding. In the following discussion, acetate (OAc) is used as an example of an organic anion that can be separated from a base in a liquid stream using the principle of selective binding. However, the approaches disclosed herein are more applicable to other organic anions including any carboxylate. In the following discussion any anion (A−) such as but not limited to Cl⁻, Br⁻, NO₃⁻, PO₄³⁻, etc. can be used to take advantage of the principle of selective binding to remove the anion from the basic liquid stream as will be disclosed in the following discussion. The separation processes involve introducing a liquid stream to an ion-exchange environment having an adsorbent positively charged material. For example, the ion-exchange environment could be a column packed with the adsorbent positively charged material. The ion-exchange environment could include a cationic resin. The adsorbent positively charged material can include materials such as but not limited to anion exchange resins, polymeric adsorbent materials, zeolites, activated carbon, nanoparticles, metal organic frameworks, molecular sieves, alumina, silica gel, and many other substances capable of adsorption.

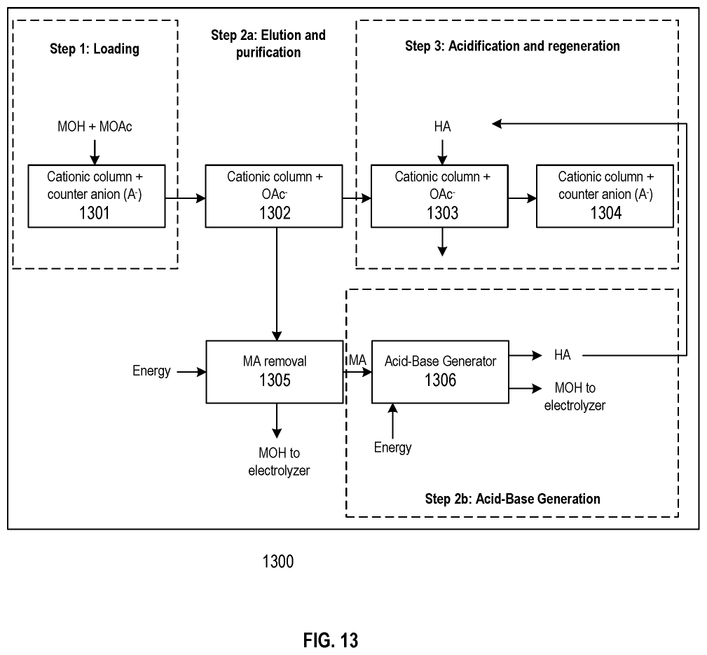

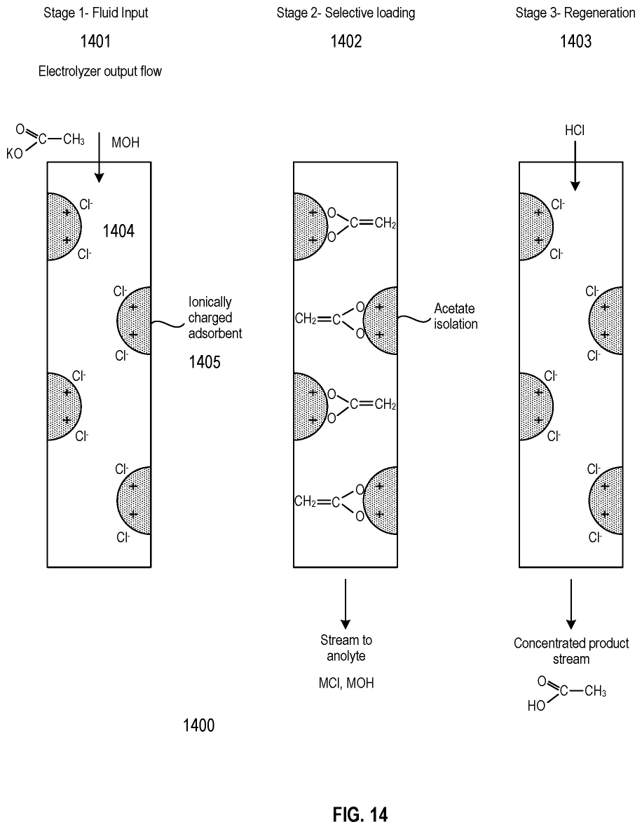

Ion exchange onto a cationic material that is selective for either acetate or hydroxide could affect the separation of a mixed stream of a carboxylate and MOH. FIG. 13 illustrates a flow chart 1300 for a set of methods that illustrate this concept. FIG. 14 illustrates an ion-exchange column as it progresses through a method that is in accordance with flow chart 1300. In a first step, a fluid stream containing MOAc and MOH is first applied to an ion-exchange environment such as an ion-exchange column 1303 or ion-exchange adsorption-bed containing cationic material 1304 and an anionic counter ion A of a strong acid 1301. The fluid stream could be an output electrolyte stream from an oxocarbon electrolyzer such as the CO electrolyzers discussed above. The MOH could be separated to increase the pH of the electrolyzer, the MOAc could be harvested as part of harvesting useful products from the system, the MOAc could also be removed for purposes of keeping the pH of the electrolyzer high. In the example of step 1 of FIG. 13 and phase 1401 in FIG. 14, the fluid stream is applied to an ion-exchange column containing the cationic material. In the example of FIG. 14, the anionic counter-ion is Cl⁻. Preferably, in embodiments in which this separating process is being used in combination with a CO electrolyzer, the counter-ion is chosen such that it is compatible with the operation of the CO electrolyzer (e.g., SO₄²⁻ or ClO₄⁻).

In a second step, the two salts MOH and MA elute through the adsorption-bed or column and are separated. As the MOAc and MOH pass through the column, one species is selectively adsorbed over the other (for example OAc⁻) yielding a purified electrolyte stream consisting of MOH and the MA (e.g., Na₂SO₄ or KClO₄) of the anion initially loaded into the column. A step such as nanofiltration or crystallization can be employed to remove MA from the mixed MA/MOH stream 1305. This process is illustrated by step 2a in FIG. 13 and phase 1402 in FIG. 14. As seen in FIG. 14, a first stream containing MCl and MOH are withdrawn from the column in this phase. The MCl can then be filtered out to produce a first stream that can be used to increase the pH of the electrolyte in an integrated CO electrolyzer.

In specific embodiments, an intermediate acid-base generator 1306 is used to recover acid and base equivalents from the MA salt produced in the previous step, as illustrated in step 2b. This process is not illustrated by an implementation in FIG. 14, but an implementation does appear as step 2b in FIG. 13. In the illustrated step, MA is split into HA and MOH via electrodialysis and the application of energy. In embodiments in which the separator is integrated with a CO electrolyzer, the MOH could be circulated to increase the pH of the electrolyte of the CO electrolyzer. The HA can also be used to recover the anionic counter-ions that were used to prepare the ion-exchange environment at the beginning of the process.

In specific embodiments, a strong acid is provided to the ion-exchange environment to yield a concentrated carboxylic acid stream and to regenerate the ion-exchange environment. The concentrated carboxylic acid stream could be the second stream referenced above in the discussion of separators for CO electrolyzers. As illustrated by step 3 in FIG. 13 and phase 1403 in FIG. 14, acetic acid is obtained by providing a strong acid HA such as but not limited to HCl, H₂SO₄, or KClO₄ to the column, yielding a concentrated acetic acid solution and regenerating the ion-exchange column 1303. In the example of phase 1403 in FIG. 14, the strong acid is HCl.

As can be seen from the example in FIG. 13 the tandem ion exchange/electrodialysis approach minimizes the wasteful acidification of unconverted MOH, enabling its recovery for recirculation into the CO electrolyzer.

In embodiments in which the ion-exchange columns 1400 of FIG. 14 are integrated with a CO electrolyzer, the liquid products can be separated from either the cathode output, anode output, or both through the separator presented in FIG. 14 for the separation of acetic acid from an acetate/MOH stream, however, this device could be used on a fluid stream having any combination of an organic anion and base.

The separation efficiency of MOH to carboxylate or any other organic anion relies on the selective adsorption of the organic anion onto the cationic material. The material (e.g., resins) can be provided as small beads that can be packed in a column or laid out on a fixed bed. The process separation efficiency can also be increased through multiple or longer columns or beds which can improve the purity of the MOH stream produced during the loading step, depending on relative affinity. Unfunctionalized high-surface area materials such as zeolites and alumina can also be used as a column material, relying on selective physisorption of acetate.

As mentioned previously, in embodiments in which the separator is integrated with a CO electrolyzer, the anion A⁻ (and corresponding conjugate acid HA for the acidification) should be selected so that it does not interfere with the operation of the CO electrolyzer. Additionally, or in the alternative, steps should be taken to remove the anion prior to provisioning the first stream back to the electrolyzer. At steady state, the concentration of alkali metal salt can be adjusted prior to provisioning to the CO electrolyzer (e.g., with a method to remove the alkali metal salt such as crystallization or nanofiltration). In specific embodiments, an MA removal step may be necessary because multiple purification cycles will yield an electrolyte that has high MA and will result in a low degree of carboxylate adsorption in the cationic column 1302. However, this salt removal process can incur substantial energy and water removal cost to crystallize and separate the two salts. Using a removal method such as crystallization incurs the salt as a waste product during Step 2a. This motivates the use of another method to recover acid and base equivalents.

The choice of A should also be made to assure that the cation material has a higher affinity for the organic anion that is meant to be separated (e.g., acetate) than for A to enforce separation during loading. Furthermore, A should be selected such that the MA salt has a substantially lower solubility than MOH to enable MA removal using crystallization. Furthermore, small amounts of MA salt should be compatible with the CO electrolysis and electrodialysis process, because the separations will be imperfect. For example, if the organic anion were acetate, then A could be KClO₄ as it includes all these characteristics when applied to the separation of acetate.

This device uses a positively charged surface to facilitate the purification through the phases 1401, 1402, and 1403 shown in FIG. 14. This high surface area interface selectively binds to the organic anions (acetate in the presented example), while letting through alkali metal hydroxide electrolyte (e.g., KOH in water) and displacing the initially present anion (in this case Cl) 804. Upon saturation of this column with the organic anion, the column is isolated from the stream and an aqueous acidic solution such as but not limited to HCl, HNO₃, H₂SO₄, HClO₄, or HBr solution is fed through the column to generate the purified liquid product (acetic acid in this case) and regenerate the column to its starting state. Many of these columns may be run in parallel to ensure continuous purification of the aqueous streams.

In specific embodiments of the invention, hydrogen generated at the cathode of an integrated CO electrolyzer is used as a feedstock to generate proton equivalents to protonate the organic anion. The proton equivalents can be generated from dihydrogen via a variety of means, such as but not limited to using the dihydrogen as a feedstock in an electrochemical cell to induce oxidation to protons or using the dihydrogen as a feedstock in a thermochemical process (such as HCl synthesis via the combination of H₂ and Cl₂) to produce an acid. If the electrolyzer generates hydrogen at the cathode as a by-product, this gas may be used to generate the acid for protonation of the organic anion.

### Tubular Separation Reactor

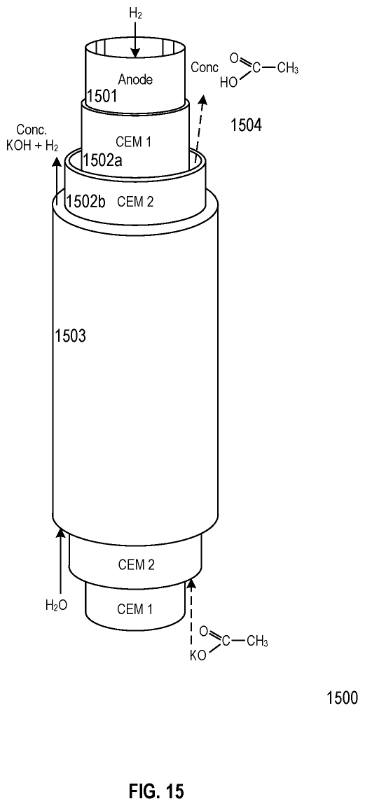

In specific embodiments of the invention, the electrodialysis reactors above may be assembled in a tubular configuration to facilitate ease of installation. An example of such an electrodialysis reactor is provided by tubular electrodialysis separator 1500 in FIG. 15. Tubular configurations can allow for more efficient operation and lower costs because of favorable process parameters, such as but not limited to improved mass transport, reduced cell volumes, reduced energy expenditure, and ease of assembly. FIG. 15 shows an example of the electrodialysis electrolyzer 600 described above being implemented in a tubular configuration. However, any of the electrodialysis reactors described above can be implemented as a tubular reactor.

FIG. 15 illustrates a tubular electrodialysis separator 1500 that can be used to separate useful products from a liquid stream, and/or to refresh an electrolyte by removing byproducts, in accordance with embodiments disclosed herein. As illustrated, an anode area 1501 of the electrodialysis electrolyzer is isolated from the separating area of the tubular electrodialysis separator 1500 by a first cation exchange membrane 1502a, the separating area 1504 of the electrodialysis electrolyzer is located between the anode area 1501 of the electrodialysis electrolyzer and the cathode area 1503 of the tubular electrodialysis separator 1500, and the cathode area 1503 of the tubular electrodialysis separator 1500 is isolated from the separating area 1504 of the tubular electrodialysis separator 1500 by a second cation exchange membrane 1502b.

### Kolbe Electrolysis Separator Processes

In specific embodiments of the invention, the separating processes disclosed herein can be conducted using Kolbe Electrolysis. Reaction of carboxylate to ethane via Kolbe electrolysis can be used to support the separation of carboxylate from a basic fluid stream. Kolbe electrolysis can be performed to oxidatively decarboxylate two acetate molecules (and any carboxylate) to form ethane (see equations below). The same reaction mechanism provides a path to form propane from one acetate and one propionate, and butane from two propionates.

Anode: 2R—CO₂⁻M→2R—CO₂·+2e⁻+2M⁺ (9)

Cathode: H₂O+2e⁻+2M⁺→H₂+2MOH (10)

Follow up anode: 2R—CO₂→R·+2CO₂ (11)

Follow up anode: 2R·→+R—R (12)

Carbonation: 2CO₂+4MOH⁻→2M₂CO₃+2H₂O (13)

Net w/carbonation: 2R—CO₂⁻M⁺2H₂O→R—R+2M₂CO₃+2H₂ (14)

Net w/o carbonation: 2R—CO₂⁻M⁺2H₂O→R—R+2MOH+H₂+2CO₂ (15)

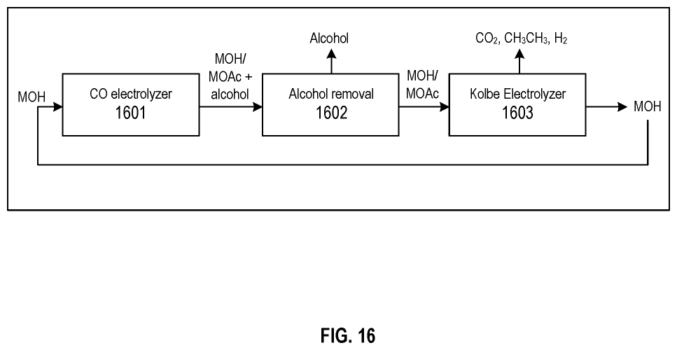

The reaction can be performed in aqueous media using a Pt anode and a H₂-evolving or O₂-reducing cathode. FIG. 16 illustrates a flow chart for a separation process using Kolbe electrolysis where the separator is integrated with an oxocarbon electrolyzer 1601. The anode of the Kolbe electrolyzer 1603 oxidizes acetate to form ethane. As the process occurs via the decarboxylation of acetate to produce CO₂, CO₂ is released at the anode. Depending on reactor configuration, this CO₂ can react with the OH formed during H₂ evolution at the cathode, leading to the formation of carbonate/bicarbonate.

Another important side reaction is the two-electron oxidation of acetate to form the methyl carbocation instead of the radical intermediate, leading to the formation of methanol (see below). Methanol is an attractive product because it can be easily distilled from an aqueous MOH solution, and either valorized or upgraded to ethylene via the methanol-to-olefins (MTO) reaction.

Anode: 2R—CO₂⁻M→2R⁺+4e⁻+2CO₂ (16)

Cathode: 2H₂O+4e⁻→2H₂+4MOH (17)

Homogeneous: 2R⁺+2OH⁻→2ROH (18)

Net w/methanol formation: 2R—CO₂⁻M⁺H₂O→2ROH+H₂+2CO₂+2MOH (19)

The efficiency of the Kolbe electrolysis process is favored in alkaline conditions, while the selectivity between the methanol and ethane pathway can be steered with the use of electrolyte additives.

The Kolbe cells can be designed such that CO₂ is rapidly removed from the solution to maintain alkalinity and minimize crossover. Otherwise, M₂CO₃ is produced as a waste product but can represent an equivalent of captured CO/CO₂ for the total process.

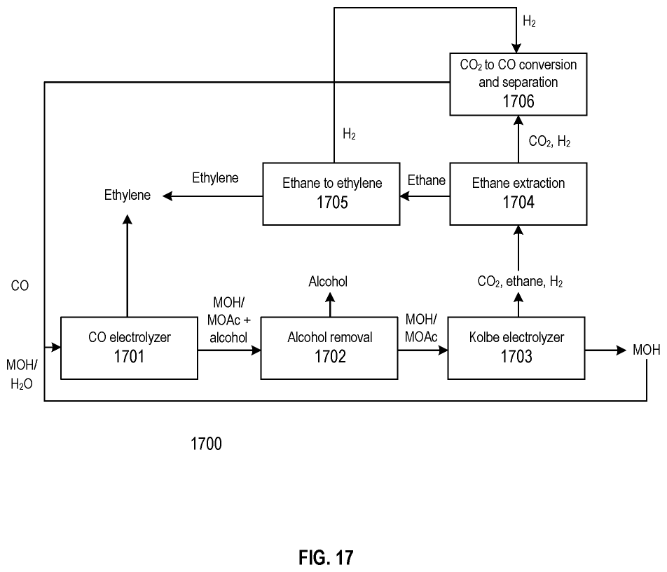

The Kolbe electrolyzer 1603 produces a segregated and concentrated stream of MOH, which can be provisioned to the CO electrolyzer. The ethane (in addition to minority propane and butane) produced can be provisioned into a cracker to generate ethylene, propene, and butene. If carbonate/bicarbonate formation is rapid, this mixture can be separated from MOH in the alcohol removal apparatus block 1602 prior to provisioning it into the Kolbe electrolyzer 1603. If unreacted with hydroxide, the CO₂ can be provisioned along with the dihydrogen generated to a separate CO₂ to CO conversion unit that can be recirculated to supply the CO electrolyzer. As illustrated by system 1700 in FIG. 17, the CO₂ to CO conversion unit 1706 can be provided with dihydrogen from an ethane to ethylene conversion unit 1705 to power the process of CO₂ to CO conversion unit 1706. In the illustrated embodiment, the target valuable chemical produced by the CO electrolyzer 1701 is ethylene such that the separation process produces an additive quantity of such valuable chemical. Further, a mixture of MOH/MOAc and alcohol is passed through alcohol removal block 1702 to produce MOH/MOAc. The MOH/MOAc is then passed to a Kolbe electrolyzer 1703. After ethane extraction in ethane extraction unit 1704 CO₂ and H₂ are transferred to the CO₂ to CO conversion and separation.

### Pyrolyzing Processes

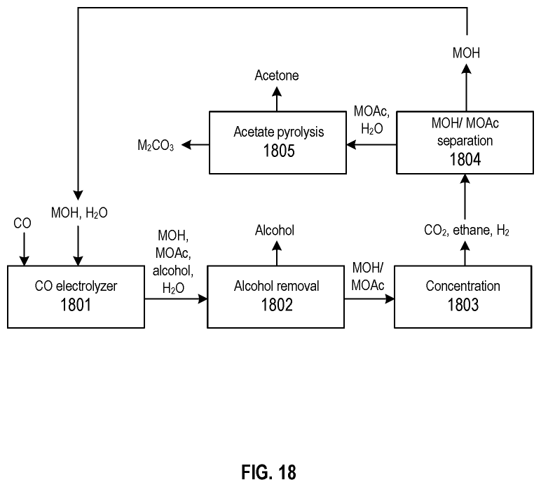

In specific embodiments of the invention, the separating processes disclosed herein can include a pyrolyzing separator process. In these embodiments, alkali metal acetate and alkali metal hydroxide can be separated, and the alkali metal hydroxide can be recirculated to the CO electrolyzer 1801 to increase the pH of the electrolyte by MOH/MOAc separation block 1804. Furthermore, the alkali metal acetate (or other carboxylate) can be pyrolyzed to produce higher value chemicals. For example, carboxylate products departing from the CO electrolyzer can be pyrolyzed to produce acetone. One route to produce acetone involves the pyrolysis of a metal acetate at 300-450° C. to form acetone 1805 (see reaction below, and FIG. 18). If performed on an impure MOH/MOAc solid solution (for example derived from a crystallization), the pyrolysis product will be a solid mixture of M₂CO₃ and MOH. Because M₂CO₃ is typically less soluble than MOH, the MOH can be dissolved with water prior to provisioning the pure MOH to the CO electrolyzer 1801. The M₂CO₃ can be treated as a waste product or taken as a captured CO₂ equivalent.

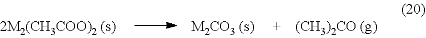

Conducting the acetate pyrolysis process 1805 to produce acetone requires the upstream removal of water from the MOH/MOAc electrolyte solution in concentration step 1803, along with an MOH/MOAc separation step to remove MOH from the MOAc. Before concentration step 1803, the stream can be passed through an alcohol removal step 1802 to remove alcohol.

### Distinct Tanks for Separation Processes

In specific embodiments, fluid streams from a CO electrolyzer can be stored in multiple tanks or be sent to one of multiple separation units to allow the separation processes described above to operate more slowly than the demands of the CO electrolyzer would otherwise allow. The multiple separation units can be multiple ion-exchange columns, multiple Kolbe electrolyzers, multiple electrodialysis electrolyzers, etc. The tanks or separation units can be connected to the CO electrolyzer through a manifold with multiple values and control systems to route the fluid stream from a specific tank or separator at one time, and then to a separate tank or separator at another time. The separation units can also be connected to the CO electrolyzer through a manifold that will route the fluid stream to multiple separation units simultaneously. Many ion-exchange environments or other separation systems, such as separating columns, can run in parallel to ensure continuous purification of the aqueous streams.

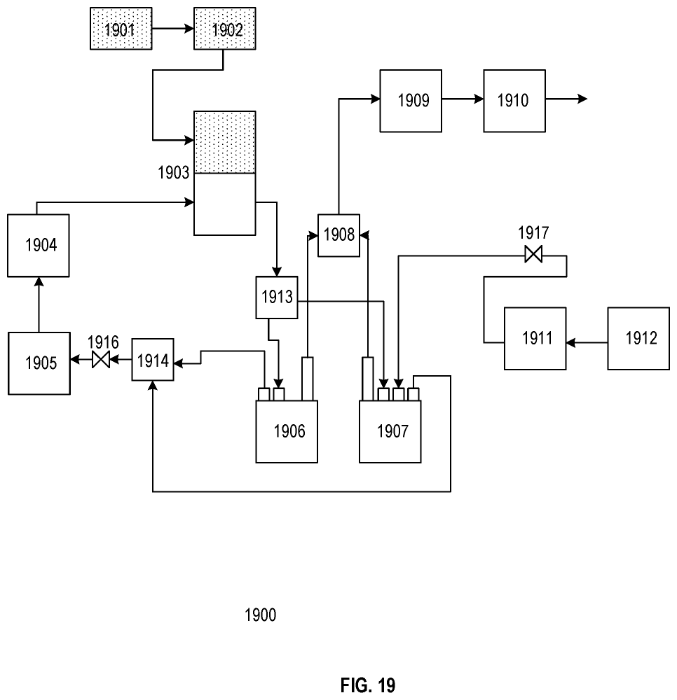

FIG. 19 illustrates an electrolyte switching system 1900 to enable continuous operation and replacement of electrolytes for CO electrolyzer with multiple electrolyte tanks 1906 and 1907 where the electrolyte can be circulated from either of the tanks 1906 and 1907 or stored in the tanks temporarily for a separation process to be executed on the stored fluid. The separation process can be conducted as the fluid is withdrawn from the tank and then replaced into the tank or it can be conducted while the fluid is in the tank.

In specific embodiments of the invention, an electrolyte switching system 1900 is provided to allow for continuous operation without degradation of performance while recirculating electrolytes as shown in FIG. 19. In specific embodiments of the invention, electrolyte must be continuously provisioned to the electrolyzer, but the electrolyte can become unsuitable for efficient operation over time due to several events, such as but not limited to consumption of hydroxide by the electrolytic process, carbonation and decline of the electrolyte pH, and accumulation of contaminants and electrolysis products. To enable continuous provision of electrolytes suitable for efficient operation, the electrolyte can be provisioned during electrolysis into the inlet of the electrolyzer from an electrolyte reservoir using a pump 1905. The electrolyte tank 1906 is connected to the inlet of the electrolyzer using a valve 1916 and a three-way valve 1914 that leads to at least one other electrolyte tank 1907. A CO supply is passed from a CO supply 1901 through a fluid controller 1902 to a cathode of the electrolyzer 1903. A heating system 1904 and a series of safety valves can be included inline of the fluid connections. The electrolyte exits the outlet port of the electrolyzer 1903 and into a second three-way valve 1913 fluidly connected to at least two electrolyte tanks 1906 and 1907. When the first electrolyte tank 1906 is depleted, the two three-way valves 1913 and 1914 can be switched to fluidly connect the second electrolyte tank 1907 to the inlet and outlet of the electrolyzer. The electrolyte in the first tank 1906 can then be regenerated or replaced through several means. When the second electrolyte tank 1907 is depleted, the two three-way valves 1913 and 1914 can be switched to fluidly connect the regenerated first electrolyte tank 1906 to the electrolyzer. The electrolyte in the second tank 1907 can then be regenerated, and the cycle can be continuously repeated to enable continuous provision of fresh electrolyte. If the anolyte compartment of the electrolyzer is operated at pressure, the two electrolyte tanks 1906 and 1907 can be fluidly and commonly connected to a pressure maintenance system. The pressure maintenance system can include one or more valves 1908 and 1910 and pressure regulators 1909 to isolate the electrolyte reservoirs to maintain consistent pressure at the electrolyzer, such as during an electrolyte regeneration cycle. A pressurized gas line 1912 is connected through valves 1911 and 1917 to flow the gas to electrolyte tank 1907.

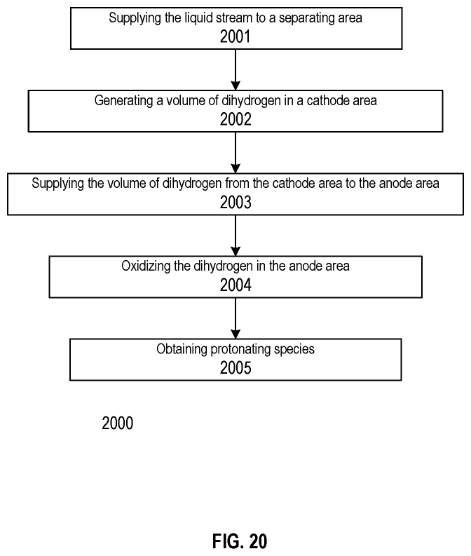

FIG. 20 discloses a process for separation 2000 comprising supplying the liquid stream to a separation area 2001. The process further comprises generating a volume of dihydrogen in a cathode area of the electrodialysis electrolyzer 2002. The process further comprises supplying the volume of dihydrogen from the cathode area to an anode area of the electrodialysis electrolyzer 2003. The dihydrogen is then oxidized in the anode area of the electrodialysis electrolyzer 2004 to obtain protonating species 2005.

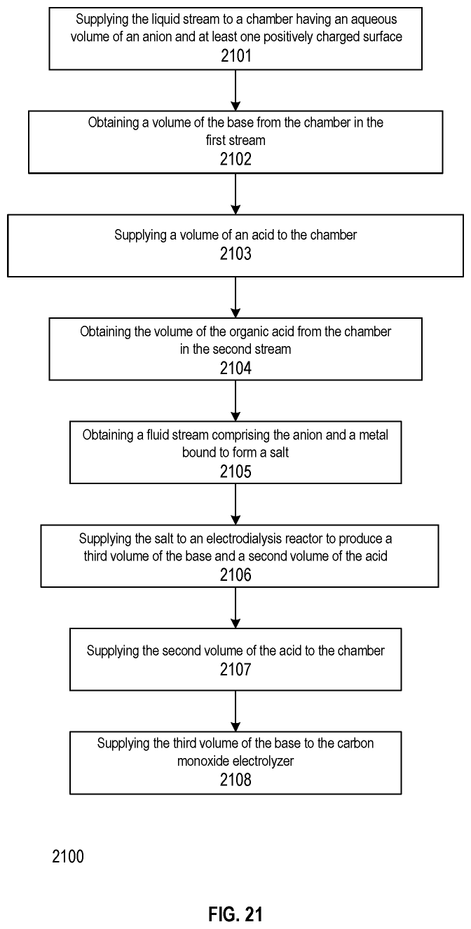

FIG. 21 discloses a separation process 2100 comprising supplying the liquid stream to a chamber having an aqueous volume of an anion and at least one positively charged surface 2101; obtaining the second volume of the base from the chamber in the first stream 2102; supplying a volume of an acid to the chamber 2103; obtaining the volume of the organic acid from the chamber in the second stream 2104; obtaining a fluid stream comprising the anion and a metal bound to form a salt 2105, supplying the salt to an electrodialysis reactor to produce a third volume of the base and a second volume of the acid 2106, supplying the second volume of the acid to the chamber 2107, and supplying the third volume of the base to the carbon monoxide electrolyzer 2108.

In specific embodiments of the inventions disclosed herein, a method illustrated by flow chart 100 comprises a step 101 of supplying a volume of oxocarbon to a cathode area of an oxocarbon electrolyzer to be used as a reduction substrate. The reduction substrate is then used in a step 102 of generating a volume of an organic anion. The method also comprises a step 103 of obtaining a liquid stream comprising the volume of the organic anion and a volume of a base from the oxocarbon electrolyzer. The method also comprises a step 104 of generating, using a separation process, and from the liquid stream, a first stream 1 and a second stream 2. The first stream and the second stream are separated by the separation process. The separation process separates a volume of a cation from the liquid stream. The first stream includes a second volume of the base, and the second stream includes a volume of an organic acid. The volume of the organic acid includes the volume of the organic anion, and the second volume of the base includes the volume of the cation. However, the separation process used in step 104 does not acidify the base. In specific embodiments, the separation process used in step 104 includes an electrodialysis process. The method further comprises recirculating the first stream to the oxocarbon electrolyzer to maintain a pH of an electrolyte of the oxocarbon electrolyzer such as CO electrolyzer 105.

An example of a separation process that can be used in step 104 is illustrated in FIG. 6 as flow chart 610 and comprises supplying the liquid stream to a separating area of an electrodialysis electrolyzer 601. The process also includes protonating, in the separating area and using a volume of a protonating species, the volume of the organic anion to generate the volume of the organic acid 602. Further, the process includes generating a volume of hydroxide anions in a cathode area of the electrodialysis electrolyzer 603. The volume of hydroxide anions and the volume of cations combine in the cathode area of the electrodialysis electrolyzer to generate the second volume of the base in the cathode area of the electrodialysis electrolyzer 604. The method further comprises obtaining the first stream from the cathode area of the electrodialysis electrolyzer 605 and obtaining the second stream from the separating area of the electrodialysis electrolyzer 606.

FIG. 6 also illustrates an anode area 600c of an electrodialysis electrolyzer 600 as isolated from the separating area 600b of the electrodialysis electrolyzer 600 by a first cation exchange membrane 600y. The separating area 600b of the electrodialysis electrolyzer 600 is located between the anode area 600c of the electrodialysis electrolyzer 600 and the cathode area 600a of the electrodialysis electrolyzer 600. The cathode area 600a of the electrodialysis electrolyzer 600 is isolated from the separating area 600b of the electrodialysis electrolyzer 600 by a cation exchange membrane 600x.

In specific embodiments of the invention, a separation process such as a separation process using a tubular electrodialysis separator 1500 comprises generating a volume of dihydrogen in the cathode area 1503 of the electrodialysis electrolyzer and supplying the volume of dihydrogen from the cathode area of the electrodialysis electrolyzer to an anode area 1502 of the electrodialysis electrolyzer. The volume of dihydrogen is oxidized in the anode area 1504 of the electrodialysis electrolyzer to form the volume of the protonating species 1505.

Another example of a separation process that can be used in step 104 is illustrated in FIG. 8 in block diagram 810. The process comprises supplying the liquid stream to a separating area of an electrodialysis electrolyzer 801, protonating in an anode area of the electrodialysis electrolyzer, and using a volume of a protonating species, the volume of the organic anion to generate the volume of the organic acid 802 and generating a volume of hydroxide anions in a cathode area of the electrodialysis electrolyzer 803. The volume of hydroxide anions and the volume of cations combine to generate the second volume of the base in the cathode area of electrodialysis electrolyzer 804. The process also comprises obtaining the first stream from the separating area of the electrodialysis electrolyzer 805 and obtaining the second stream from the anode area of the electrodialysis electrolyzer 806.

FIG. 8 also illustrates anode area 800c of the electrodialysis electrolyzer 800 as isolated from the separating area 800b of the electrodialysis electrolyzer 800 by an anion exchange membrane 800y. The separating area 800b of the electrodialysis electrolyzer 800 is located between the anode area 800c of the electrodialysis electrolyzer 800 and the cathode area 800a of the electrodialysis electrolyzer 800. The cathode area 800a of the electrodialysis electrolyzer 800 is isolated from the separating area 800b of the electrodialysis electrolyzer 800 by a second anion exchange membrane 800x. Separation process 2000 further comprises generating a volume of dihydrogen in the cathode area of the electrodialysis electrolyzer 2002 and supplying the volume of dihydrogen from the cathode area of the electrodialysis electrolyzer to the anode area of the electrodialysis electrolyzer 2003. In this step, the volume of dihydrogen is oxidized in the anode area of the electrodialysis electrolyzer 2004 to form the volume of the protonating species 2005.

In specific embodiments of the invention, separation process 2100 further comprises supplying the liquid stream to a chamber having an aqueous volume of an anion and at least one positively charged surface 2101. Steps of implementation in accordance with process 2100 are illustrated in FIG. 14. In the process, organic anion 1404 binds to at least one positively charged surface 1405. The process also includes obtaining a volume of the base from the chamber in a first stream 2102 that is withdrawn from the chamber and supplying a volume of an acid to chamber 2103. The acid includes the organic anion 1404, and the volume of the organic anion 1404 is converted to a volume of the organic acid. The process also includes obtaining a volume of the organic acid from the chamber in a second stream 2104 that is withdrawn from the chamber.

At least one positively charged surface 1405 can be formed by an ionically charged adsorbent material; and the acid can be selected from a group consisting of HCl, HNO₃, H₂SO₄, HClO₄, and HBr.

The method further comprises obtaining a fluid stream comprising the anion and a metal bound to form a salt 2105, supplying the salt to an electrodialysis reactor to produce a volume of the base and a volume of the acid 2106, supplying the second volume of the acid to the chamber 2107, and supplying the third volume of the base to the carbon monoxide electrolyzer 2108. In the illustrated process, the organic anion 1404 can be acetate, the organic acid can be acetic acid, the base can be one of potassium hydroxide and sodium hydroxide, the cation can be one of potassium and sodium, and the reduction substrate is carbon monoxide.

In specific embodiments, the liquid stream is obtained from an anode area of the oxocarbon electrolyzer and the cathode area of the oxocarbon electrolyzer. The separation processes of the present invention, such as those conducted in step 104, can be conducted by a single separator. In specific embodiments, the methods can further comprise recirculating a first stream from the separator to the oxocarbon electrolyzer to maintain a pH of an electrolyte of the oxocarbon electrolyzer such as CO electrolyzer 105. The cathode area 201 can be a gaseous phase area. The liquid stream can be obtained from the anode area using a gas-liquid separator 206.

In specific embodiments, the separation process can use a membrane for a nanofiltration process. The separation process can monitor the liquid stream on one side of the membrane for a concentration and divert the liquid stream away from the membrane when the concentration passes a threshold.

In specific embodiments, a reduction substrate of the electrodialysis electrolyzer is one of water, protons, dioxygen, nitrate, chlorine, bromine, a metal ion, a metal oxide, and a metal complex.

In specific embodiments, the separation process further comprises generating a volume of dihydrogen in a cathode area of the oxocarbon electrolyzer 2002 and supplying the volume of dihydrogen to an anode area of the electrodialysis electrolyzer 2003. In the process, the first stream and the second stream are generated by the electrodialysis electrolyzer using the volume of dihydrogen as an oxidation substrate.

In specific embodiments, the methods disclosed further comprise recirculating the first stream to the oxocarbon electrolyzer to maintain a pH of an electrolyte of the oxocarbon electrolyzer such as CO electrolyzer 105, and recirculating, while generating the first stream and the second stream, a third stream to the oxocarbon electrolyzer to maintain the pH of the electrolyte, where the third stream was generated in a prior iteration of the separation process.

In specific embodiments of the invention, a method, such as in flow chart 910, comprises supplying a volume of oxocarbon carbon to a cathode area of an oxocarbon electrolyzer to be used as a reduction substrate 905. The method also comprises generating a volume of an organic anion using a reduction substrate 906. The method also comprises obtaining a first liquid stream from an anode area of the oxocarbon electrolyzer and a second liquid stream from a cathode area of the oxocarbon electrolyzer 907. The first liquid stream and the second liquid stream include the volume of the organic anion and a volume of a base. The method also comprises generating, using a separation process and from the first liquid stream and the second liquid stream, a basic stream wherein the basic stream includes a second volume of the base. The method also comprises recirculating the basic stream to the anode area of the oxocarbon electrolyzer to maintain a pH of an electrolyte of the oxocarbon electrolyzer 913.

In specific embodiments of the invention, the separation process is conducted by a single separator that receives the first liquid stream and the second liquid stream from the cathode area and the anode area. In alternative embodiments, separate separators are used for those to streams. In specific embodiments, the cathode area 904b is a gaseous phase area, and the second liquid stream is obtained from a trap on the cathode output. In specific embodiments, the first liquid stream is obtained from the anode area of the oxocarbon electrolyzer using a gas-liquid separator.

In specific embodiment of the invention, the separation process comprises the separation process in block diagram 810 which is conducted by a first separator and a second separator, the first separator obtains the first liquid stream 1, the second separator obtains the second liquid stream 2, and the first separator and the second separator produce the basic stream in combination.

In another embodiment of the invention, a method comprises supplying a volume of oxocarbon to a cathode area of an oxocarbon electrolyzer to be used as a reduction substrate; generating a volume of an organic anion using the reduction substrate; obtaining a liquid stream from the oxocarbon electrolyzer. The liquid stream includes the volume of the organic anion and a volume of a base. The method also comprises generating, using a separation process and from the liquid stream, a first stream and a second stream. The first stream and the second stream are separate. The separation process separates a volume of a cation from the liquid stream. The first stream includes a second volume of the base. The separation process uses Kolbe electrolysis to oxidatively decarboxylate the organic anion. The second volume of the base includes the volume of the cation.

While the specification has been described in detail with respect to specific embodiments of the invention, it will be appreciated that those skilled in the art, upon attaining an understanding of the foregoing, may readily conceive of alterations to, variations of, and equivalents to these embodiments. The disclosure of volumes of chemicals in this disclosure is not meant to refer to a physically isolated volume as it is possible for a volume of dihydrogen to exist with a volume of carbon dioxide in a single physical volume in the form of a volume of syngas. Although examples in the disclosure were generally applied to industrial chemical processes, the same approaches are applicable to chemical processing of any scale and scope. Furthermore, although the separator technologies disclosed herein were generally applied to separating liquid products for oxocarbon electrolyzers, the separator technologies disclosed herein are more broadly applicable to separating liquid products generally. In specific embodiments of the invention, the separators disclosed herein may be used as shown in FIG. 2 but for a CO₂ electrolyzer reactor in place of the CO electrolyzer. Furthermore, although examples in this disclosure were directed to the separation of an organic anion from a liquid product stream, approaches herein are broadly applicable to the separation of an anion from a liquid product stream. These and other modifications and variations to the present invention may be practiced by those skilled in the art, without departing from the scope of the present invention, which is more particularly set forth in the appended claims.

What is claimed is:

1. A method comprising:
supplying a volume of oxocarbon to a cathode area of an oxocarbon electrolyzer to be used as a reduction substrate;
generating a volume of an organic anion using the reduction substrate;
obtaining a liquid stream from the oxocarbon electrolyzer, wherein the liquid stream includes the volume of the organic anion and a volume of a base; and
generating, using a separation process and from the liquid stream, a first stream and a second stream, whereby the first stream and the second stream are separate, and wherein the separation process uses a membrane for a nanofiltration process;
wherein: (i) the separation process separates a volume of a cation from the liquid stream; (ii) the first stream includes a second volume of the base; (iii) the second stream includes a volume of an organic acid; (iv) the volume of the organic acid includes the volume of the organic anion; and (v) the second volume of the base includes the volume of the cation.

2. The method of claim 1, wherein:
the separation process includes the nanofiltration process and an acid-base separation process;
the nanofiltration process generates a concentrated salt solution;
the acid-base separation process generates the volume of the organic acid; and
the nanofiltration process and the acid-base separation process generate the second volume of the base.

3. The method of claim 2, wherein:
the acid-base separation process includes an electrodialysis process.

4. The method of claim 2, wherein:
the acid-base separation process uses a bipolar membrane electrodialysis process.

5. The method of claim 2, wherein:
the acid-base separation process uses an acid-base generation process;
the acid-base separation process uses an organic acid removal system;
the nanofiltration process and the acid-base generation process generate the second volume of the base; and
the organic acid removal system generates the second stream.

6. The method of claim 1, wherein the separation process comprises:
applying the liquid stream to the membrane to produce a concentrated organic salt solution;
acidifying the concentrated organic salt solution with a volume of generated acid to produce a volume of an organic acid and alkali metal salt solution;
removing the volume of the organic acid from the volume of organic acid and metal salt solution to produce a volume of a metal salt solution and the second stream; and
applying the volume of the metal salt solution to an acid-base generator;
wherein the acid-base generator generates the volume of generated acid and uses the volume of the metal salt solution to generate more of the generated acid.

7. The method of claim 6, further comprising:
recirculating the first stream to the oxocarbon electrolyzer to maintain at least one of a pH and a conductivity of an electrolyte of the oxocarbon electrolyzer;
wherein the acid-base generator and the nanofiltration process generate the first stream.

8. The method of claim 6, wherein:
the acid-base generator uses an electrodialysis process.

9. The method of claim 6, wherein:
the acid-base generator uses a bipolar membrane electrodialysis electrolyzer.

10. The method of claim 1, wherein the separation process further comprises:
supplying the liquid stream to a separating area of an electrodialysis electrolyzer;
protonating, using a volume of a protonating species, the volume of the organic anion to generate the volume of the organic acid;
migrating, across a cation exchange membrane, the volume of cations into a base chamber of the electrodialysis electrolyzer;
generating a volume of hydroxide anions in a cathode area of the electrodialysis electrolyzer, whereby the volume of hydroxide anions and the volume of cations combine in the base chamber of the electrodialysis electrolyzer to generate at least a part of the second volume of the base in the cathode area of the electrodialysis electrolyzer;
obtaining at least a part of the first stream from the base chamber of the electrodialysis electrolyzer; and
obtaining the second stream from the electrodialysis electrolyzer.

11. The method of claim 10, wherein:
an anode area of the electrodialysis electrolyzer is isolated from the acid chamber of the electrodialysis electrolyzer by a first bipolar membrane;
the separating area of the electrodialysis electrolyzer is located between the acid chamber of the electrodialysis electrolyzer and the base chamber of the electrodialysis electrolyzer; and
the cathode area of the electrodialysis electrolyzer is isolated from the base chamber of the electrodialysis electrolyzer by a second bipolar exchange membrane.

12. The method of claim 10, wherein:
the protonating step occurs in an acid chamber of the electrodialysis electrolyzer;
the acid chamber is separated from a separating chamber of the electrodialysis electrolyzer by an anion exchange membrane;
the supplying step involves supplying the liquid stream to the separating chamber; and
the second stream is obtained from the acid chamber of the electrodialysis electrolyzer.

13. The method of claim 1, wherein:
the organic anion is one of acetate and propionate;
the organic acid is one of acetic acid and propionic acid;
the base is one of potassium hydroxide and sodium hydroxide;
the cation is one of potassium and sodium; and
the reduction substrate is carbon monoxide.

14. The method of claim 1, wherein:
the liquid stream is obtained from an anode area of the oxocarbon electrolyzer and the cathode area of the oxocarbon electrolyzer;
the separation process is conducted by a single separator; and
the method further comprises recirculating the first stream to the oxocarbon electrolyzer to maintain at least one of a pH and a conductivity of an electrolyte of the oxocarbon electrolyzer.

15. The method of claim 14, wherein:
the cathode area is a gaseous phase area; and
the liquid stream is obtained from the anode area using a gas-liquid separator.

16. The method of claim 1, further comprising:
generating a useful species using the oxocarbon electrolyzer;
wherein: (i) the useful species is the organic acid; and (ii) the second stream is a purified stream of the organic acid.

17. The method of claim 1, further comprising:
supplying the liquid stream to an electrodialysis electrolyzer; and
obtaining the first stream and the second stream from the electrodialysis electrolyzer;
wherein a reduction substrate of the electrodialysis electrolyzer is one of dioxygen, water, protons, nitrate, chlorine, bromine, a metal ion, a metal oxide, and a metal complex.

18. The method of claim 17, further comprising:
generating a volume of dihydrogen in a cathode area of the oxocarbon electrolyzer; and
supplying the volume of dihydrogen to an anode area of the electrodialysis electrolyzer;
whereby the first stream and the second stream are generated by the electrodialysis electrolyzer using the volume of dihydrogen as an oxidation substrate.

19. The method of claim 1, further comprising:
recirculating the first stream to the oxocarbon electrolyzer to maintain at least one of a pH and a conductivity of an electrolyte of the oxocarbon electrolyzer; and
recirculating, while generating the first stream and the second stream, a third stream to the oxocarbon electrolyzer to maintain at least one of a pH and a conductivity of the electrolyte, wherein the third stream was generated in a prior iteration of the separation process.

20. A system comprising:
an oxocarbon electrolyzer having a volume of oxocarbon in a cathode area as a reduction substrate, and generating a volume of an organic anion using the reduction substrate;
a liquid stream from the oxocarbon electrolyzer, wherein the liquid stream includes the volume of the organic anion and a volume of a base;
a separator conducting a separation process on the liquid stream to generate a first stream and a second stream, whereby the first stream and the second stream are separate; and
a nanofiltration membrane forming part of the separator and used in the separation process;
wherein: (i) the separation process separates a volume of a cation from the liquid stream; (ii) the first stream includes a second volume of the base; (iii) the second stream includes a volume of an organic acid; (iv) the volume of the organic acid includes the volume of the organic anion; and (v) the second volume of the base includes the volume of the cation.

21. The system of claim 20, further comprising:
an acid-base separator that receives a concentrated salt solution from the nanofiltration membrane;
wherein the acid-base separator generates the volume of the organic acid; and the nanofiltration membrane and the acid-base separator generate the second volume of the base.

22. The system of claim 20, further comprising:
an electrodialysis electrolyzer that receives a concentrated salt solution from the nanofiltration membrane;
wherein the electrodialysis electrolyzer generates the volume of the organic acid; and the nanofiltration membrane and the electrodialysis electrolyzer generate the second volume of the base.

23. The system of claim 22, further comprising:
an acid-base generator;
an organic acid removal system;
wherein the system is configured to:
generate, using the acid-base generator, a volume of generated acid using the acid-base generator;
apply the liquid stream to the nanofiltration membrane to produce a concentrated organic salt solution;
acidify the concentrated organic salt solution with the volume of generated acid to produce a volume of an organic acid and alkali metal salt solution;
remove, using the organic acid removal system, the volume of the organic acid from the volume of organic acid and alkali metal salt solution to produce a volume of an alkali metal salt solution and the second stream;
apply the volume of the metal salt solution to the acid-base generator; and
generate, using the acid-base generator, more of the generated acid using the volume of the alkali metal salt solution;
wherein the acid-base generator generates the volume of generated acid and uses the volume of the alkali metal salt solution to generate more of the generated acid.

24. The system of claim 23, wherein:
the acid-base generator is a bipolar membrane electrodialysis electrolyzer.

25. A method comprising:
supplying a volume of oxocarbon to a cathode area of an oxocarbon electrolyzer to be used as a reduction substrate;
generating a volume of an organic anion using the reduction substrate;
obtaining a liquid stream from the oxocarbon electrolyzer, wherein the liquid stream includes the volume of the organic anion and a volume of a base; and
generating, using a separation process and from the liquid stream, a first stream and a second stream, whereby the first stream and the second stream are separate, and wherein the separation process uses a bipolar membrane electrodialysis process;
wherein: (i) the separation process separates a volume of a cation from the liquid stream;
(ii) the first stream includes a second volume of the base; (iii) the second stream includes a volume of an organic acid; (iv) the volume of the organic acid includes the volume of the organic anion; and (v) the second volume of the base includes the volume of the cation.

26. The method of claim 25, wherein:
the separation process includes a nanofiltration process and an acid-base separation process;
the nanofiltration process generates a concentrated salt solution;
the acid-base separation process generates the volume of the organic acid;
the acid-base separation process uses the bipolar membrane electrodialysis process; and
the nanofiltration process and the acid-base separation process generate the second volume of the base.

27. The method of claim 25, wherein the separation process comprises:
applying the liquid stream to a nanofiltration membrane to produce a concentrated organic salt solution;
acidifying the concentrated organic salt solution with a volume of generated acid to produce a volume of an organic acid and metal salt solution;
removing the volume of the organic acid from the volume of organic acid and metal salt solution to produce a volume of a metal salt solution and the second stream; and
applying the volume of the metal salt solution to an acid-base generator;
wherein the acid-base generator generates the volume of generated acid and uses the volume of the metal salt solution to generate more of the generated acid.

28. The method of claim 25, further comprising:
recirculating the first stream to the oxocarbon electrolyzer to maintain at least one of a pH and a conductivity of an electrolyte of the oxocarbon electrolyzer.

29. The method of claim 25, wherein the separation process further comprises:
supplying the liquid stream to a separating area of an electrodialysis electrolyzer;
protonating using a volume of a protonating species, the volume of the organic anion to generate the volume of the organic acid;
migrating, across a cation exchange membrane, the volume of cations into a base chamber of the electrodialysis electrolyzer;
generating a volume of hydroxide anions in a cathode area of the electrodialysis electrolyzer, whereby the volume of hydroxide anions and the volume of cations combine in the base chamber of the electrodialysis electrolyzer to generate at least a part of the second volume of the base in the cathode area of the electrodialysis electrolyzer;
obtaining at least a part of the first stream from the base chamber of the electrodialysis electrolyzer; and
obtaining the second stream from the acid chamber of the electrodialysis electrolyzer.

30. The method of claim 29, further comprising:
migrating, across an anion exchange membrane, the volume of the organic anion into an acid chamber of the electrodialysis electrolyzer, whereby the protonating of the volume of the organic anion occurs in the acid chamber; and
obtaining the second stream from the acid chamber of the electrodialysis electrolyzer.
